(19) United States
(12) Patent Application Publication
(10) Pub. No.: US 2020/0250188 A1
(43) Pub. Date: Aug. 6, 2020

(54) SYSTEMS, METHODS AND DATA STRUCTURES FOR EFFICIENT INDEXING AND RETRIEVAL OF TEMPORAL DATA, INCLUDING TEMPORAL DATA REPRESENTING A COMPUTING INFRASTRUCTURE

(71) Applicant: Zenoss, Inc., Austin, TX (US)

(72) Inventors: Ian C. McCracken, Austin, TX (US); John A.F. Crocker, III, Austin, TX (US); John L. Hamilton, Cedar Park, TX (US); Summer Samir Mousa, Austin, TX (US)

(21) Appl. No.: 16/666,481

(22) Filed: Oct. 29, 2019

Related U.S. Application Data
(60) Provisional application No. 62/800,042, filed on Feb. 1, 2019.

(51) Int. Cl. G06F 16/2458; G06F 16/22; G06F 16/23

(52) U.S. Cl. CPC G06F 16/2477; G06F 16/2322; G06F 16/221; G06F 16/2471

(57) ABSTRACT

Embodiments of systems and methods for data storage and retrieval systems are disclosed. Embodiments provide formats for a data store, and associated indexing and query implementations, to index and search messages describing the state of identifiable items. Embodiments of the data formats are optimized both for high-speed handling of out of order time series data, and high-speed queries of such data and do not require reception or processing of this data in temporal order.

### RELATED APPLICATIONS

This application claims a benefit of priority under 35 U.S.C. § 119 from U.S. Provisional Patent Application No. 62/800,042 filed Feb. 1, 2019, by inventors McCracken et al., entitled “SYSTEMS, METHODS AND DATA STRUCTURES FOR EFFICIENT INDEXING AND RETRIEVAL OF TEMPORAL DATA, INCLUDING TEMPORAL DATA REPRESENTING A COMPUTING INFRASTRUCTURE”, the entire contents of which are hereby fully incorporated by reference herein for all purposes.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates generally to a data formats and structures for data storage, retrieval, distribution or transmission. In particular, this disclosure relates to compact data structure formats for the storage and indexing of time based data that allow for efficient and rapid querying or searching of such time based data. Specifically, embodiments disclosed herein relate to a database structure for the storage and indexing of time based data pertaining to the monitoring or management of entities in a computing environment that allows for rapid retrieval of such data using arbitrarily complex queries, among other advantages.

### BACKGROUND

In today's distributed computing environments, the need to index, search and store data is ever increasing. In no small part this is because, computing platforms and data collection, aggregation and analysis are continually growing more complex. Much of the data collected and analyzed may be time sequenced data that may be utilized in various contexts such as historical analysis of data, training of computer models (e.g., machine learning model or the like) over time, real-time monitoring of real world entities or computing devices or platforms (e.g., Internet of Things (IOT) devices), predictive modeling of certain environments, etc. Accordingly, the need to index, search and store high volumes of time series or sequenced data is of particular importance.

A microcosm of these needs occurs in the context of the monitoring and management of modern, distributed computing environments. As may be realized, knowledge of the structure of this type of computing environment is crucial to diagnosing problems, or otherwise monitoring or managing, such a computing environment. A modern computing environment may, however, comprise a plurality of identifiable entities, including but not limited to physical computers, virtualized computers, containers, processes, and serverless compute functions. For example, an enterprise computing environment associated with an organization may utilize thousands of network-connected devices and their related entities, such as workstations, servers, tablets, and mobile devices. These devices may themselves devices include virtualized hardware, software or other functional instances. The software entities on these devices may include, for example, operating systems, applications, database systems, web servers, web-based applications, security monitors, or the like that may themselves by utilized in association with other entities. Knowledge of such a complex environment may therefore prove difficult to obtain, manage or utilize in the context of management or monitoring that environment.

Further complicating this situation is the fact that some of these entities exist for months or years, while others are more ephemeral, and may exist only for seconds or less. Moreover, each of the entities may change, and change at different intervals, during their existence. The applications deployed into these highly dynamic environments are often correspondingly complex, spanning multiple cloud providers and private data centers. As a result, when problems with these applications or other entities occur, diagnosing their root cause with any degree of certainty or timeliness depends on evaluating information in context that can only be obtained by analyzing the structure of the environment at the time the problem occurred.

Thus, not only does data have to be collected on the various and myriad entities in the distributed computing environment for effective monitoring and management, but in order to be useful the data on the entities of the computing environment may need to be regularly updated. In modern distributed systems, this is difficult, as there is usually no single source in a computing environment that reliably describes its structure. Building a model from disparate sources is error-prone.

More specifically, because of the immense scale and dynamic nature of these computing environments, maintaining knowledge of their structure a priori by synchronizing with provisioning (also known as source) systems that provide data on the entities in the environment is error prone and costly. The problem is compounded in hybrid environments, where dozens of independent actors, both human and automated, may be responsible for provisioning infrastructure. Current monitoring and management systems therefore typically maintain only indirect knowledge of the existence and interconnectedness of computing infrastructure entities, primarily by inference from metadata accompanying telemetry data such as metrics, logs, traces or other data collected from the environment. Inferring structure from telemetry metadata is usually incomplete due to lossy collection and storage.

Moreover, for reasons of scale, and to avoid impacting the performance of the entities (e.g., applications and computing devices) being observed, telemetry data are typically sampled, or collected only periodically from providers in the computing environment. This practice, given the ephemerality of compute entities in question, also contributes to an incomplete record of the structure of the compute environment. As a further complication, telemetry data cannot be guaranteed to be received in temporal order, requiring costly reconciliation of secondary indices pertaining to time to maintain close-to-real-time access to inferences about the environment. Additionally, such telemetry data may have a high cardinality.

These considerations lead to a trifecta of problems in the context of management and monitoring of computing systems: indexing high-cardinality data is expensive; indexing high-cardinality data (that may change) over time is very expensive; and indexing high-cardinality data over time without a guarantee of (e.g., receiving data in) temporal order is extremely expensive.

Previous solutions have proved inadequate to addresses these various issues. One approach is to disregard the structure of the environment and trust statistics obtained from the telemetry to perform monitoring and management of the computing environment. This approach relies on having sufficient volume of telemetry data from the computing environment to guarantee an effective signal. Such an approach may be adequate to the determination of unknown problems, but, there is no guarantee such problems will be detected in real time given the variability in timing and completeness of telemetry data. Additionally such data may be more difficult to analyze after a problem occurs because collection is lossy. Importantly, this approach does not solve the issue that the storage and indexing (e.g., and querying) of this type of high-cardinality data in time is slow and expensive.

Another approach to the management and monitoring of computing environment data is to construct and maintain an a priori view or structure representing the environment being monitored and managed. Such a view or structure may be constructed at least in part by human provisioner. However, because these provisioners are human, these provisioners sometimes fail to do what they say they're going to do, and there may be many provisioners working at a given time. As a result, the constructed view is usually incomplete and either rife with false negatives or time-shifted by some amount. As added disadvantages, such an approach may only be applied to deal with previously known and contemplated issues and transactional reconciliation of such a structure is slow and expensive.

What is desired then, are systems, methods and data structures that allow for efficient storing, indexing and querying of data representing the state of computing entities over time.

### SUMMARY

To address those needs, among others, embodiments as disclosed a data store or database (referred to herein interchangeably) or table structure and associated query methods to analyze and index messages describing the state of identifiable items. These items (also referred to as entities) may be almost anything of interest that it is desired to store, whether physical, logical, virtual, real or imaginary in almost any context desired. For example, these items may comprise things (e.g., devices, software application, processes, models, event, metrics) associated with a computing environment. As data (e.g., in messages) representing the state of identifiable entities are received by the system, the data is stored in a data store in tables structured for rapid queries. This data store may be, for example, a columnar data store such as Hbase or Bigtable. Data (e.g., messages) may be received in any order and may be handled in parallel or series.

In one embodiment, for example, a data storage and retrieval system, may receive a message and update one or more tables in a data store based on the message. The tables in the data store may include a first table (which may be referred to here as the item-field name-value table or FIELD_TS table without loss of generality), where a first entry in the first table includes a first primary key including an identifier for an item, a field name and a first timestamp indicating when a message for the item including the field name was received and wherein the first entry includes a field name value for the field name included in the message. The data store can also include a second table (which may be referred to here as the item-field name-value-time table or FIELD_INDEX table without loss of generality), where a second entry in the second table includes a second primary key including the field name, the field name value, the identifier for the item, a second timestamp indicating when the field name value was valid for the field name and the item, and a presence indicator indicating if the field name value is valid or removed.

The data store can, in embodiments, include a third table (which may be referred to here as the field name-value-time table or VALUE_INDEX table without loss of generality), where a third entry in the third table includes a third primary key message including the field name and the field name value, and wherein the first entry includes a field name value for the field name and wherein the third entry includes a third timestamp of a first time a pair of the field name and the field name value was received in the message and a second time for each time the pair of the field name and the field name value in which the message affected the pair of the field name and the field name value.

In some embodiments, the data store is a columnar data store such as Hbase or Bigtable.

In a particular embodiment, the third entry in the third table includes a count for the field name and field name value, where the count is associated with a number of second entries in the second table associated with the field name and field name value.

In one embodiment, the second primary key of the second entry in the second table includes an optional snapshot indicator and the first timestamp is an inverted timestamp.

In other embodiments, the first primary key, second primary key and third primary key include a tenant and a type associated with the message.

Embodiments as presented herein may thus have a number of advantages including providing systems and data storage formats that are optimized both for high-speed writes of time series data and high-speed queries of contextual data. Moreover, these systems do not require reception or processing of this data in temporal order for correctness. Thus, embodiments of such systems may accept and index high-cardinality data with minimal delay while maintaining a complete picture of the items represented by the messages over time and retaining the ability to be pruned and optimized as data become less timely. Embodiments may also be capable of executing complex queries and joining across data types and is accordingly structured for immediate rapid retrieval using arbitrarily complex queries.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of an network computing environment including an embodiment of an IT management system.

FIGS. 2-4 are diagrammatic representations of tables that may be used by embodiments of an IT management system

FIG. 5 is a flow diagram of one embodiment of message processing in an IT management system.

FIG. 6 is a flow diagram of one embodiment of query evaluation in an IT management system.

FIGS. 7A, 7B and 7C are a flow diagram of one embodiment of query evaluation in an IT management system.

FIGS. 8A and 8B depict an embodiment of an interface.

### DETAILED DESCRIPTION

In today's distributed computing environments, the need to index, search and store data is ever increasing. A microcosm of this problem occurs in the context of the monitoring and management of modern, distributed computing environments. As may be realized, knowledge of the structure of this type of computing environment is crucial to diagnosing problems, or otherwise monitoring or managing, such a computing environment. A modern computing environment may, however, comprise a plurality of identifiable items, including but not limited to physical computers, virtualized computers, containers, processes, and serverless compute functions. For example, an enterprise computing environment associated with an organization may utilize thousands of network-connected devices and their related entities, such as workstations, servers, tablets, and mobile devices. Knowledge of such a complex environment may therefore prove difficult to obtain, manage or utilize in the context of management or monitoring that environment. Further complicating this situation is the fact that some of these entities exist for months or years, while others are more ephemeral, and may exist only for seconds or less.

Thus, not only does data have to be collected on the various and myriad entities in the distributed computing environment for effective monitoring and management, but in order to be useful the data on the entities of the computing environment may need to be regularly updated. In modern distributed systems, this is difficult. Current monitoring and management systems therefore typically maintain only indirect knowledge of the existence and interconnectedness of computing infrastructure entities, primarily by inference from metadata accompanying telemetry data such as metrics, logs, traces or other data collected from the environment. Inferring structure from telemetry metadata is usually incomplete due to lossy collection and storage. Moreover, for reasons of scale, and to avoid impacting the performance of the entities (e.g., applications and computing devices) being observed, telemetry data are typically sampled, or collected only periodically from providers in the computing environment. This practice contributes to an incomplete record of the structure of the compute environment. As a further complication, telemetry data cannot be guaranteed to be received in temporal order, requiring costly reconciliation of secondary indices pertaining to time to maintain close-to-real-time access to inferences about the environment.

These considerations lead to a variety of problems in the context of management and monitoring of computing systems including: indexing high-cardinality data is expensive; indexing high-cardinality data over time is very expensive; and indexing high-cardinality data over time without a guarantee of temporal order is extremely expensive.

What is desired then, are systems, methods and data structures that allow for efficient storing, indexing and querying of data representing the state of computing entities over time.

To address those needs, among others, embodiments as disclosed a database structure and corresponding query algorithm to analyze and index messages describing the state of identifiable entities, including those comprising a computing environment. As data (e.g., in messages) representing the state of identifiable items (also referred to herein interchangeably as entities) are received by the system, the data can be stored in a columnar data store (e.g., Hbase or Bigtable) in tables structured for rapid queries. Data (e.g., messages) may be received in any order and may be handled in parallel, although messages pertaining to the same identifiable entity may be processed in series. It will be noted again here that while embodiments as disclosed may be described with respect to the indexing and querying of message data regarding the state of entities in a computing environment over time, other embodiments may be usefully applied in almost any other context where the indexing and querying of time based data may be desired as will be understood, and all such embodiments and applications are fully contemplated herein. Additionally, it should be noted here for purposes of terminology that the term item is used herein interchangeably with the term entity.

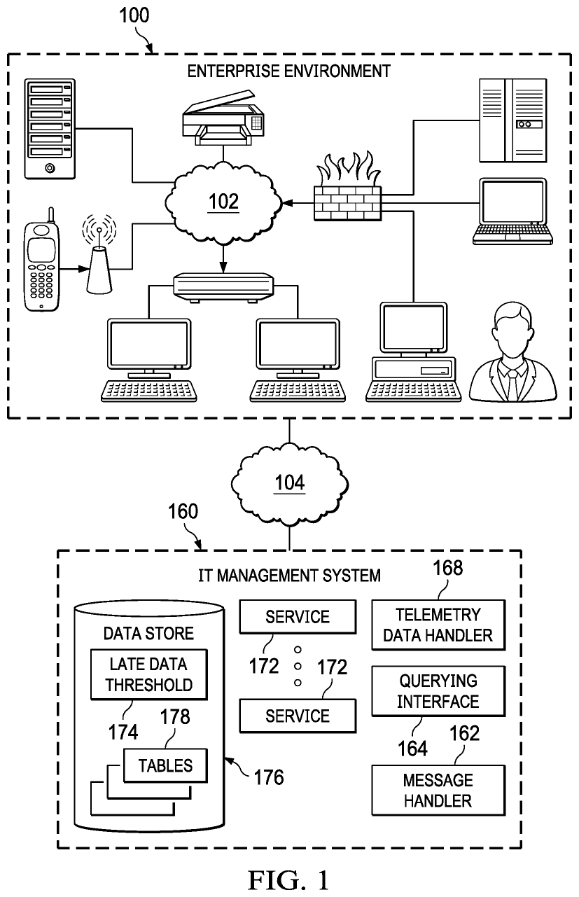

Before proceeding further with a description of embodiments, it may be useful to discuss a high level overview of the architecture of an embodiment of an information technology (IT) management system and a computing environment in which such an IT management system may be usefully applied. Looking then at FIG. 1, a distributed networked computer environment including one embodiment of an IT management system is depicted. Here, the networked computer environment may include an enterprise computing environment 100. Enterprise environment 100 includes a number of computing devices or software (e.g., applications) that may be coupled over a computer network 102 or combination of computer networks, such as the Internet, an intranet, an internet, a Wide Area Network (WAN), a Local Area Network (LAN), a cellular network, a wireless or wired network, or another type of network. The enterprise environment 100 may thus comprise a plurality of identifiable entities, including but not limited to physical computers, virtualized hardware, containers, processes, serverless compute functions, workstations, servers, tablets, mobile devices, operating systems, applications, database systems, web servers, web-based applications, security monitors, etc. Each entity may itself be associated with one or more subentities that are themselves entities, or one or more parent entities.

To assist in managing and mentoring the entities of the enterprise environment 100, an IT management system 160 may be employed. The IT management system 160 (or portions thereof) may be included in enterprise environment 100 or may be coupled to the enterprise environment 100 (or portions thereof) through computer network 104 (which may the same as, a part of, a subnetwork of, include, or different from, computer network 102). Accordingly data on the structure of enterprise environment 100 is crucial to IT management system 160 in diagnosing problems, or otherwise monitoring or managing, enterprise environment 100. Accordingly, IT management system 160 may collect or obtain data about the entities in enterprise environment 100. This data may take the form of messages representing the state of computing entities and their subcomponents over time. Specifically, the messages may identify a particular entity, some attribute associated with the entity, and one or more values for that attribute.

Specifically, there may be a number of collectors or harvesters associated with the enterprise environment 100 deployed within the enterprise environment 100, or remotely from the enterprise environment 100, that are configured to collect data from various sources within the enterprise environment 100, generate messages regarding the entities of the enterprise environment 100 from the data, and send those messages to the IT management system 160. Alternatively, there may be a number of collectors or harvesters associated with the enterprise environment 100 deployed within the enterprise environment 100, or remotely from the enterprise environment 100, that are configured to collect data regarding entities within the enterprise environment 100 (e.g., telemetry data or the like as discussed) and provide that data to the IT management system 160. This data may be evaluated by telemetry data handler 168 to generate these messages regarding the entities of the enterprise environment 100.

In one embodiment, when used in a multi-tenant environment where the IT management system 160 may be responsible for monitoring or managing the IT infrastructure for multiple enterprise environments (e.g., tenants) the message may take the format of,

{

| | |
|---|---|
| tenant: | “tenant value” |
| type: | “type value” |
| id: | “id value” |
| timestamp: | “timestamp value” |
| data | { |

| fieldname1: | [“value1”,“value2”,...”valueN”], |
|---|---|
| fieldname2: | [“value1”,“value2”,...”valueN”], |
| ... | |
| fieldnameN: | [“value1”,“value2”,...”valueN”] |

}

}

Tenant and type are examples of immutable dimensions in this embodiment, the owner (e.g., tenant enterprise) and type of the item described by the message. The id of the message may also be immutable in this embodiment and is the external identifier of the item described by the message. The timestamp of the message is the moment (e.g., in milliseconds since the epoch) at which the message completely describes the item identified by the immutable dimensions tenant, type and id. The data field of the message is a map of field names (or fields) to arrays of values. The contents of this map may be treated as a representation of the entity at the moment in time described by timestamp. It will be noted here that the fields and choice of dimensions of a message may differ depending on the implementation of various embodiments and that certain fields may or may not be present in the format of various embodiments of messages and all such message formats are fully contemplated herein.

These messages may thus represent, or include data pertaining to, the state of the entities of the enterprise environment 100 over time. Whether generated externally or internally to the IT management system 160, these messages may be received at the message handler 162 of the IT management system 160. The message handler 162 may store and index the data of these messages in set of tables 178 of the data store 176 of the IT management system. The data store 176 may, for example, be a (e.g., sparse) columnar store such as HBase or Bigtable. Such a data store may, for example, have the features that rows in a table are stored and returned in lexicographical order by primary key; columns in a row are stored and returned in lexicographical order by column qualifier; and writes are atomic at the row level. In certain embodiments, the message handler 162 may also update or optimize the tables in the data store 176 at (the expiration of a) configurable time period referred to herein as the late data threshold 174 (e.g., a time period or counter that expires and is restarted). This late data threshold 174 may be configurable and, in some embodiments, may be on the order of an hour. In these types of embodiments, attempts to write out of order data (e.g., messages being received or processed out of time order based on the associated timestamp) after such a later data threshold 174 may be relatively more costly with respect to memory, time or other computing resources.

The IT management system 160 may thus utilize the data in the tables 178 of the data store 176 for a large variety of management or monitoring tasks or applications, as may be contemplated. Specifically, in certain embodiments, the IT management system 160 may include one or more service 172 which perform monitoring or management tasks using the entity data stored in the data store 176 to obtain the valuable structural context necessary to evaluate the IT infrastructure of enterprise environment 100 (e.g., at a particular time or during a particular time interval. These services 172 may, for example, including monitoring or root cause analysis interfaces or the like. Accordingly, the IT management system 160 may include a querying interface 164 through which queries can be submitted (e.g., by services 172 or other components of an IT management system 160) and the queries efficiently evaluated (e.g., executed) against the tables 178 stored in the data store 176 to return data responsive to the queries.

These queries may, for example, include Boolean queries with constraints on matching fields and effective time intervals. The time intervals specified in the query may include explicit time intervals specified in the query though the use of two points in time, or may be implicit. For example, a query may be submitted without a time period and the time interval may implicitly be from a present time (first time point) to the beginning of time (e.g., a second time point). As another example, a query may be submitted with a single point of time (first time point) with some indicator of whether the query is intended to cover a previous time period (e.g., the second time point is the beginning of time) or a time period since the single point of time (e.g., the second time point is the present time). Execution of these queries against the tables 178 of entity data in the data store 176 may return: the values of the fields requested for each entity matching the constraints of the query and for each time interval that the entity matched the query.

Table structure for the tables 178 of entity data stored in the data store 176 may be structured to accept and index high-cardinality data with minimal delay and to accept and correctly index entity data that is received out of temporal order. Moreover, such tables 178 may maintain a substantially complete picture of the entities represented by the received messages over time and be structured for substantially immediate rapid retrieval using arbitrarily complex Boolean queries all while being capable of being pruned and optimized as data becomes less timely.

In particular, in one embodiment, the tables 178 of the data store 176 may include a FIELD_TS table, a FIELD_INDEX table and a VALUE_INDEX table. It will be noted that the names of these tables are given for purposes of illustration and that other names (or no names) may be given to the various tables without loss of generality. Moreover, it will be noted that certain of the tables (or values within those tables) illustrated may be provided or utilized for the sake of further or greater optimization of particular embodiments and that certain other embodiments may utilize fewer (or more) of these types of tables (or values) while also achieving the enumerated advantages, among others.

In one embodiment, then, the FIELD_TS table stores a log of the values for each field for each message received for each entity. The FIELD_INDEX table indexes the transitions in state from present to absent for each individual member value of each field for each message received for each entity; and the VALUE_INDEX table indexes each field value, irrespective of the entity for which it is destined, along with a count. This count may be, for example of the number of matching items within a period for the history of that value's presence or a number of rows of the FIELD_INDEX table that may be needed to be passed over to resolve that field and value.

It will now be useful to an understanding of embodiments as described to go into more detail regarding embodiments of each of these tables 178. To assist in describing embodiments, examples of these table will be described with respect to the following example message, without loss of generality:

{

| | |
|---|---|
| tenant: | “acme” |
| type: | “entity” |
| id: | “id_1” |
| timestamp: | “1544560208168” |
| data | { |

| | |
|---|---|
| alpha: | [“a”, “b”,”c”]. |
| beta: | [“d”], |

}

}

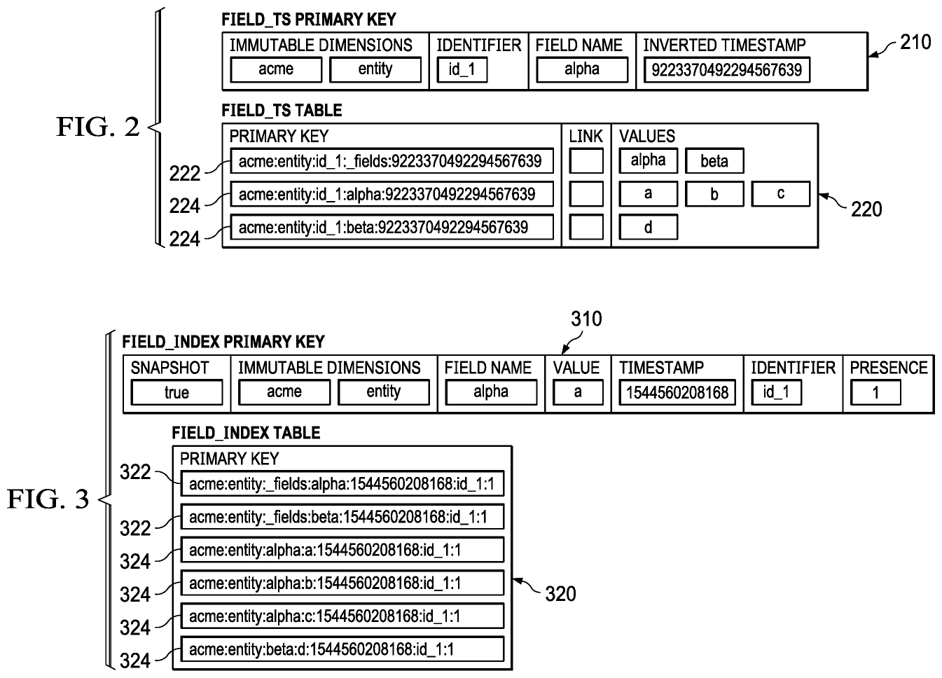

Referring now to FIG. 2, a block diagram of one embodiment of the FIELD_TS table is depicted. Here, FIELD_TS table is a latest-first log of all entity-field pairs over time. Area 210 shows a depiction of the primary key for the FIELD_TS table. The primary key of the FIELD_TS table is structured to enable fast resolution of specific fields for an entity within given time intervals. The key comprises: the immutable dimensions and identifier of the entity (here, the tenant, type and id fields of a message), the field name for the entry (here, the example key is for the “alpha” fieldname) and an inverted, or ones complement, of the timestamp of the message that provided the data. By utilizing an inverted timestamp entries in the FIELD_TS table for the same entity and field may held in the table in order of recency. The columns of the FIELD_TS table comprise one or more “value” columns, each value column containing the complete member values for that field name at this time (e.g., as received in the message). In particular embodiments, the FIELD_TS table may include a “link” column, that contains the timestamp of the message (if any) that provided or included the previous value for this item-field pair, as well as whether the previous value was different. This column may be used, for example, when scanning within a particular time interval, to resolve the value of the field for the period preceding the first (time) value within the interval.

Area 220, for example, shows examples of entries in the FIELD_TS table that would be generated based on the example message above. Here, notice that there is one entry in the table for each field (e.g., alpha and beta) of the message, where each entry 224 has a primary key constructed as described and includes all the values for that field included in that message. In one embodiment, there may also be an entry 222 in the table referred to as a metafield entry for a message that describes the names of the fields (e.g., here alpha and beta) included in the message.

As a brief example of the use of a FIELD_TS table, for the given example in FIG. 2, resolving the value of field alpha for id_1 during the time interval [t2, t4) would include a scan of rows of the table 220 in the prefix range [acme:entity:id_1:alpha:complement(t4), acme:entity:id_1:alpha:complement(t2)). Upon reaching the final row of the FIELD_TS table in the time interval, analysis of the value of the “link” column in that row would determine whether a second range scan of the FIELD_TS table may be needed to resolve the value of that field prior to the beginning of the query interval (here “t2”). If the value of the “link” column indicates that the previous message was outside the scan (e.g., time) interval and the field value was not different at that time (as determined by the entry associated with the link column), or if the link value for the determined entry is empty (indicating the field did not exist previous to the last row), no further scan of the FIELD_TS table may be necessary.

Moving on to FIG. 3, a block diagram of one embodiment of the FIELD_INDEX table is depicted. The FIELD_INDEX table is a log of item-field-member values becoming valid or being removed or changed. The FIELD_INDEX table tracks the presence of member values over time, and may be used to determine items indexed by the IT management system that exhibited the (or a given) member value within a given time interval. In certain embodiment, “snapshot” rows may also be written to the FIELD_INDEX table aggregating the results of an item-field-member value over time.

Area 310 shows a depiction of the primary key for an entry the FIELD_INDEX table. The primary keys of the FIELD_INDEX table may also include the immutable dimensions and the name of the field, along with the field member value itself. In one embodiment, this value may be a compressed version of the field value to save space. As the FIELD_INDEX table may not be directly scanned for query matching and exact value may not be needed. The key for an entry in the FIELD_INDEX table may also include the timestamp (e.g., of the message) at which the member value was valid and the identifier of the item associated with the message for which the entry was created. The key for the FIELD_INDEX table may also include a “presence” Boolean indicating whether the associated entry describes the member value as being valid or removed. A “false” value means that this member value of the associated entry was, prior to the timestamp of that row, valid, but the message that led to this row being written did not include it. There may be no columns in the FIELD_INDEX table other than the primary key.

Primary keys of the FIELD_INDEX table comprise an optional indicator of snapshot status. The indicator may be a flag, Boolean or string such that if the indicator is presence it may indicate the row associated with the key is a snapshot row. By using such an indicator as the initial value in the key it may easily be determined which rows of the FIELD_INDEX table are snapshots and which are an item-field-member value for a particular time. To explain in more detail, after looking at the depiction of the FIELD_INDEX table, it may be realized that some item (e.g., in an enterprise environment) may change relatively infrequently. Thus, to optimize time based quires related to entity data stored in the data store 176, certain tables, rows or values may be generated and utilized to optimize such queries. For example, despite the fact that certain entities indexed by the IT management system 160 may change rarely if ever, when a query related to those entities is received, in order to determine time intervals to return (e.g., for when an item-field-member value or portion thereof was present or not present), a query evaluator may need to scan the substantially entire FIELD_INDEX table to determine the complete time intervals for that item for that query in order to process the query.

This type of scan would slow down queries over time as more data is indexed and more rows are added to the table. A summary of the data in the FIELD_INDEX table may therefore prove useful in further optimizing querying for such time based data. The FIELD_INDEX table, therefore, may have one or more rows written upon some trigger (e.g., by the message handler 162)—when a query is evaluated, periodically, on demand, or based on analysis of indexed data—that “sums up” an item or item-field-member value at some time closer to the present than a previously received message (e.g., for that item). The columns of the snapshot rows thus contain the item identifiers that exhibited the field:member value at the moment of the snapshot. In addition, the row keys are prepended with an indicator (e.g., bit, byte, flag, Boolean, string, etc.) that the row is a snapshot row. As is explained in more detail, the time of a snapshot will be stored into the VALUE_INDEX table, allowing any appropriate snapshot row in the FIELD_INDEX table to be ascertained and accessed, for example, during query evaluation by querying interface 164.

Accordingly, in certain embodiments, during the execution stage of query evaluation, a scan across the snapshot rows of the FIELD_INDEX table representing the most recent snapshot for an item, member field or value may be made while scanning the rows of the FIELD_INDEX table. The scan of the FIELD_INDEX table may then commence from that point, rather than having to scan from the beginning of time. Specifically, it will be realized that because the row keys are prepended with an indicator (e.g., Boolean) that the row is a snapshot row during a given scan of the FIELD_INDEX table any snapshot rows that include the values of the key (e.g., a time value) being used for the scan will be encountered before any rows that include the value of the key that are not snapshot rows. This means not only may any snapshot rows be encountered first during a given scan of the FIELD_INDEX table (e.g., before non-snapshot rows) and be processed or utilized to avoid subsequent scanning of non-snapshot rows, but additionally, these snapshot rows may be obtained along with non-snapshot rows of the FIELD_INDEX table during a concurrent scan.

Area 320 of FIG. 3 shows the entries in the FIELD_INDEX table that would be generated based on the example message above. Here, notice that there is one entry 324 in the table for each field-value pair (e.g., alpha/a, alpha/b, alpha/c and beta/d) of the message, where each entry 324 has a primary key constructed as described and includes the name of the field, the value, the timestamp of the message, the identifier of the entity and a presence value indicating the value for the field was valid at that timestamp. In one embodiment, there may also be entries 322 in the table referred to as metafield entry for a message that describes the names of the fields (e.g., here alpha and beta) included in the message, where the presence values for those entries indicates that the field itself was present for that entity at that time.

As a brief example of the use of a FIELD_INDEX table for the given example in FIG. 3, determining entities that exhibited the value alpha:a within the time range [t0, t5) would scan the key range [acme:entity:alpha:a:t0, acme:entity:alpha:a:t5), parsing the identifier and presence from the primary key for each row 324 of the FIELD_INDEX table encountered, and saving an item-field-member value-interval each time the presence value of a row 324 flips from true to false for that item.

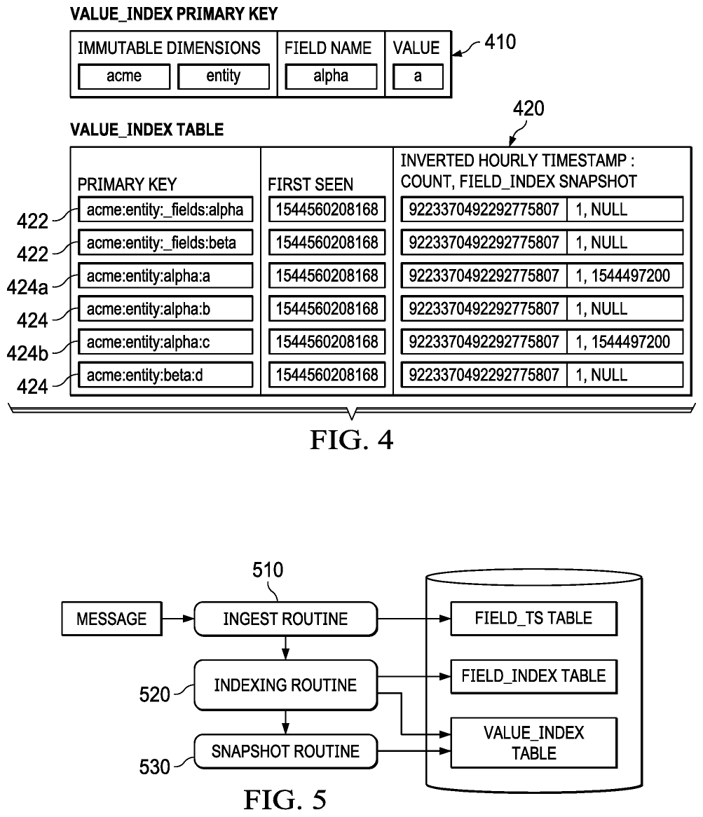

Looking next at FIG. 4, a block diagram of one embodiment of the VALUE_INDEX table is depicted. The VALUE_INDEX table is an index of counts (e.g., that may be approximate or exact counts) of matching items for all field-member value pairs encountered (e.g., since the beginning of the epoch). It may be structured to enable scans of the VALUE_INDEX table to find member values that match a given constraint.

Area 410 shows a depiction of the primary key for an entry the VALUE_INDEX table. Primary keys of the VALUE_INDEX table comprise the immutable dimensions and the name of the field. The key may also comprise the field member value itself. The columns of the VALUE_INDEX table comprise a “First Seen” column for a timestamp describing the first time the field:member value pair was seen. This timestamp may be used to reduce a requested time interval requested to one in which the value exists. The columns may also include a column (“Inverted Hourly Timestamp:Count”) for every hour in which a message affected the field:member value pair, either by encountering it in a message or by determining it was removed from entity. This column may be, for example, populated by a message handler after the late data threshold 174 has passed. This column may include a qualifier that is the ones complement of the timestamp denoting the end of the time period associated with the late data threshold (e.g., hour), and the column value includes both a count (e.g., which may be an approximation) of entities that have the value within that preceding time period as well as a timestamp of the last FIELD_INDEX snapshot made (if any) for that field-member value combination. The count may also be a number of rows that a scan of the FIELD_INDEX table will have to pass over to resolve field-value pair

These counts of items that have the value may be realized after a time period (e.g., the late data threshold or the granularity of the time period of the VALUE_INDEX table) has passed. To update these counts, in one embodiment, an asynchronous process may perform the scans of the FIELD_INDEX table to determine the counts and updates the appropriate VALUE_INDEX column for each time period that saw a message affecting that field:member value pair. As will be realized, as the actual data in the tables may have changed (e.g., more messages may have been received and indexed since the last count update) these counts may not always be completely accurate. Thus, these counts are sometimes referred to as “estimated” counts herein.

Area 420 of FIG. 4 shows the entries in the VALUE_INDEX table that would be generated based on the example message above (e.g., at the expiration of a late data threshold 174). Here, notice that there is one entry 424 in the table for each field-value pair (e.g., alpha/a, alpha/b, alpha/c and beta/d) of the message, where each entry 424 has a primary key constructed as described and includes the name of the field and the value. The columns include a timestamp indicating the first time that value was seen for that field and a column with the ones complement of the timestamp of the message along with a count of how many entities have that value as of the timestamp of the message (in this example “1”). Note also, that two of the entries 424a, 424b have an additional value in the last column indicating a timestamp of the last FIELD_INDEX snapshot made for that field-member value combination (e.g., while the other entries have NULL, indicating a snapshot has not been made). In one embodiment, there may also be entries 422 in the table referred to as metafield entries that describes the names of the fields (e.g., here alpha and beta) and describing when that field was first seen and a count of how many entities had that field at that time.

In one embodiment, when a query is performed on the message data, this query may be optimized using an estimation. The estimation stage of queries may utilize the counts (e.g., rough counts) of the number of matches for each field:member value from the VALUE_INDEX table to allow a query execution planner to optimize query execution more effectively. Specifically, in one embodiment, scanning the VALUE_INDEX table for matching field:member values makes use of whatever filters are provided by the specific columnar store used for data store 176—for example, scanning by prefix, regular expression, or within a range. The columns requested may stretch much further back in time, and the scan halted after the first column and at least one estimate is returned.

Now that the structure of embodiments of tables employed by embodiments of an IT management system have been described, attention is now turned to the handling of received messages to create or update such tables. In one particular embodiment each message may be handles in a set of stages. FIG. 5 is a block diagram depicting one embodiment of a method for creating or updating tables in the data store based on a received message. Such a method may, for example, be implemented by a message handler of a system according to particular embodiments.

When a message is received it may be processed in three stages, ingest stage 510, indexing stage 520 and snapshot stage 530. During the ingest stage (also referred to as a routine) 510, a message is received. Internal fields representing metadata about the message may be generated and added to, or associated with the message. For example, a field listing the names of the fields present in the message may be added to the stored message. The message can then be split by field and one row per field of the message may be written to the FIELD_TS table with a key created from the message as described above and including the values for that field for that message. The ingest stage 610 updates each FIELD_TS row just written (e.g., the “link” column) with the timestamp of the most recently received previous message (if one exists) that described a value array different from the current (e.g., where one or more values for the field are different or present than the message just received).

The ingest stage 510 can then calculate from the previous state (if any) of the item (e.g., as stored in the tables) which field values (e.g., for that entity) are new and which are no longer valid—that is, the “presence” of each member value implicated by the message can be determined. Based on this determination the ingest stage 510 schedules (e.g., asynchronous) the indexing of the value presences calculated. This scheduling may take the form of placing a job in a job queue of the system (e.g., in a persistent queue).

During the indexing stage 520, the member value presences (e.g., jobs) scheduled by the ingest stage 510 can be read from the queue. For each of the scheduled index of a member value for an item determined from the message, the indexing stage 520 can write one row for each member value to the FIELD_INDEX table and write one row for each member field and value to the VALUE_INDEX table. It will be noted that such a write may not be necessary if a corresponding row is already present. In other words, such a write may only result in a new row in the VALUE_INDEX table if that value has never been seen before for that field for any item at all. The indexing stage 520 also schedules a future member value summarization task (e.g., after the expiration of the time period associated with the late data threshold) for each member value for each field in the VALUE_INDEX table. This scheduling may take the form of placing a job in a job queue of the system (e.g., in a persistent queue).

During the snapshot stage 530, the member value summarization tasks older than the late data threshold (e.g., hour) may be determined (e.g., from the persistent queue in which they were entered by the indexing stage 520). For each of the determined member value tasks (e.g., scheduled summarization task), the snapshot stage 530 scans the FIELD_INDEX table to determine the number of items that exhibit the member value for the field specified in the member value summarization task during a previous time period associated with the late data threshold (e.g., an hour). This determination can be made based on the timestamp of the message that initiated the member value summarization task (e.g., the message that was received and that is being processed).

Moreover, in one embodiment, the number of rows of the FIELD_INDEX table that were scanned to determine the count may also be tracked during this scan of the FIELD_INDEX table. If the determined number of rows is significantly larger (e.g., on the order of ten times as many, a hundred times as many, a thousand times as many or some other configurable snapshot threshold which may be an absolute value, ratio or other measure) than those that would make up a snapshot (e.g., the number of matching items), a snapshot row is also written to the FIELD_INDEX table representing the item identifiers that exhibited that field value at the expiration of the late data threshold (e.g., at the expiration of that hour). The determined count (e.g., the number of entities that exhibit the member value for the field or the number of rows that may be passed over in a scan of the FIELD_INDEX table for the that field value pair) along with the time the snapshot row (if any) in the FIELD_INDEX time was created can then be written to the VALUE_INDEX table row representing the member value for this field associated with the late data threshold time period (e.g., hour) during which the value was seen. Embodiments of the ingest and snapshot processes and the tables of embodiments may be better understood with reference to Appendices A and B below, where Appendix A depicts an example illustrating the ingest of example messages while Appendix B depicts an example illustrating the creation of snapshots in tables of certain embodiments.

With the tables as discussed above in mind, it will now be useful to discuss embodiments of how such tables may be utilized to perform a query to obtain data stored in such tables. For example, in order to obtain structural context needed to evaluate an environment tracked by the IT management system when problems occur, Boolean queries with constraints on matching fields and effective time intervals may be made through querying interface 164, where these queries may be evaluated against the data of the messages as processed and contained in the tables as described. These queries may, for example, include Boolean queries with constraints on matching fields or effective time intervals. The time intervals specified in the query may include explicit time intervals (or points in time) specified in the query through the specific explication of two points in time (e.g., in the query itself), or one or more time may be implicit to the query. Execution (e.g., evaluation) of the queries using the tables 178) of these queries may return, for example, the values of the fields requested, for each item matching the constraints of the query and for each time interval that each of the items matched the terms of the query.

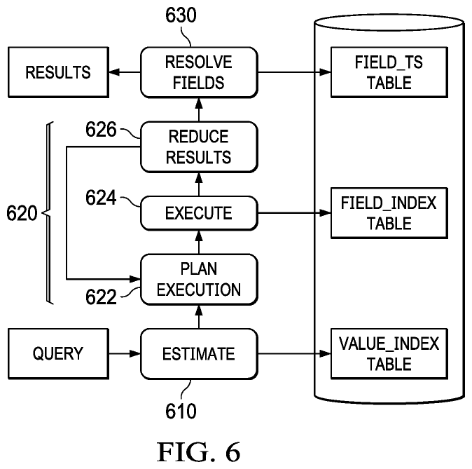

FIG. 6 is a block diagram depicting one embodiment of a method for evaluating a received query using embodiments of the tables discussed. When a query is received it may be processed in three stages, estimation stage 610, execution stage 620 and resolution stage 630. At the estimation stage 610, for each clause in the query, the VALUE_INDEX table is scanned to determine matching field:member value pairs; the estimated count of items with that value within the interval (or each interval) requested in the query; and the timestamp of the last FIELD_INDEX snapshot, if any, for each match. These scans may, for example, be done in parallel during the same scan (or scans) of the VALUE_INDEX table. This scan can be done by constructing appropriate row keys based on the terms in the query (e.g., the include field name or value along with the tenant or type of item if included) and scanning the VALUE_INDEX table based on the constructed key to determine rows of the VALUE_INDEX table keyed by that key.

During the execution stage 620, then, the field:member value pairs determined during the estimation stage 610 can be resolved into item-interval pairs for which those values (e.g., the values as specified in the query) are valid. Specifically, in one embodiment, using the counts determined during the estimation stage 610, an execution plan may be built at step 622, selecting the order in which to resolve items from field:member value pairs. The FIELD_INDEX table can then be scanned according to the determined plan (e.g., order) at step 624 utilizing any snapshots determined during estimation stage 610. By taking advantage of any determined snapshots it may be possible for example, to start the scan of the FIELD_INDEX table for a field:member value at a snapshot row that occurred at a time just prior to a time period or interval associated with the query.

Due to the structure of that table in certain embodiments, the rows of the FIELD_INDEX table may be processed in an order that allows keeping track of the intervals during which items fit the constraint of the query, by determining when presence fields of the associated row turn on and off (e.g., flip from 1 to 0 or 0 to 1). These scans can be done completely in parallel or batched, or otherwise. When dependent clauses of the query have been fully executed (e.g., results are determined from each dependent clause) Boolean operators are applied to all the resulting item-interval pairs, reducing multiple clauses (e.g., for each dependent clause) into a result sets at step 626. The steps 622, 624, 626 are repeated until no clauses of the original query remain. The execution step may result in a set of any item-interval pairs for which clauses of the query are true.

At step 630, for each of these item-interval pair determined during execution stage 620, the FIELD_TS table is scanned to resolve requested field values (e.g., in the query) of the item and intervals (e.g., determine in the execution stage). The results may then be aggregated, sorted and returned in response to the originally received query.

It will now be useful to an understanding of embodiments to illustrate specific examples. Again, recall that standard Boolean queries with constraints on matching fields and effective time intervals are received by the system. Execution of these queries can return the values of the fields requested for each item matching the constraints of the query or each time interval that the item matched the query. Other examples of the evaluation of queries and associated results are depicted in Appendix C.

So, for purposes of illustration, assume the following messages have been indexed by the system:

{

tenant: “acme”,
type: “entity”,
id: “item1”,
timestamp: t0,
data: {

a: [1, 2],
b: [4],
c: [5]

}

}
{

tenant: “acme”,
type: “entity”,
id: “item1”,
timestamp: t2,
data: {

a: [1, 3],
b: [4],
c: [6]

}

}
{

tenant: “acme”
type: “entity”,
id: “item1”,
timestamp: t4,
data: {

a: [1, 2, 3],
b: [4],
c: [7]

}

}

Now suppose the system receives the following query (written here in pseudo-SQL for clarity):

SELECT b WHERE a=2 DURING [t0, t5)

According to this example, the following results would be returned by embodiments of an system using embodiments of the tables as depicted, illustrating the periods during which the query was matched:

[

{

id: “item1”,
b: [4],
interval: [t0, t2)

},
{

id: “item1”,
b: [4],
interval: [t4, t5)

}

]

Now compare that result with a query that matches during the entire time lifespan of an item:

SELECT b WHERE a=1 DURING [t0, t5)

Here, embodiments of an IT management system would return the following results in response to this query, illustrating the constancy of both the field value and the constraint satisfaction:

[

{

id: “item1”,
b: [4],
interval: [t0, t5)

}

]

Finally, a query that matches during the entire lifespan of the item that selects a field that changes during that interval can be illustrated as follows:

SELECT c WHERE a=1 DURING [t0, t5)

In this case, embodiments of an IT management system return the following results:

[

{

id: “item1”,
c: [5],
interval: [t0, t2)

},
{

id: “item1”,
c: [6],
interval: [t2, t4)

},
{

id: “item1”,
c: [7],
interval: [t4, t5)

}

]

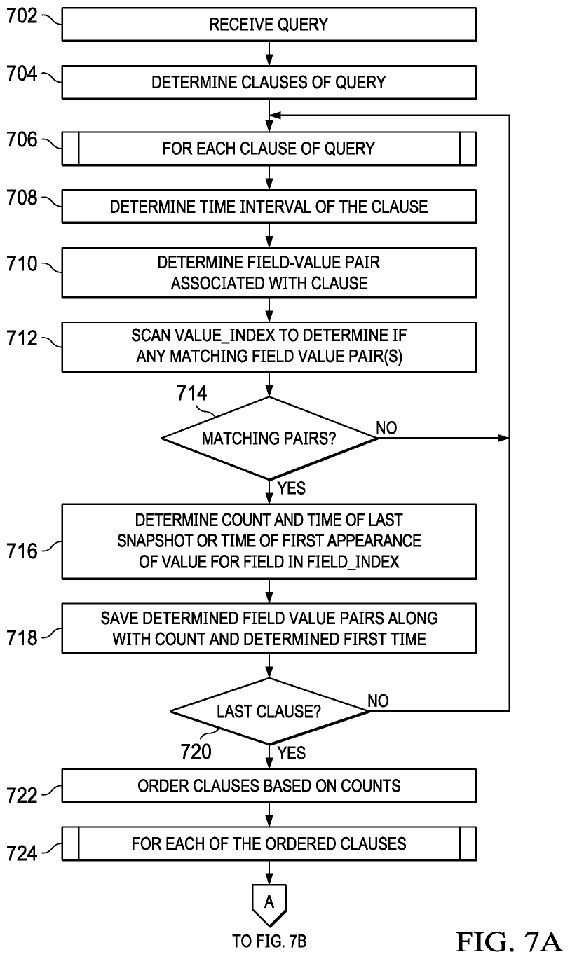

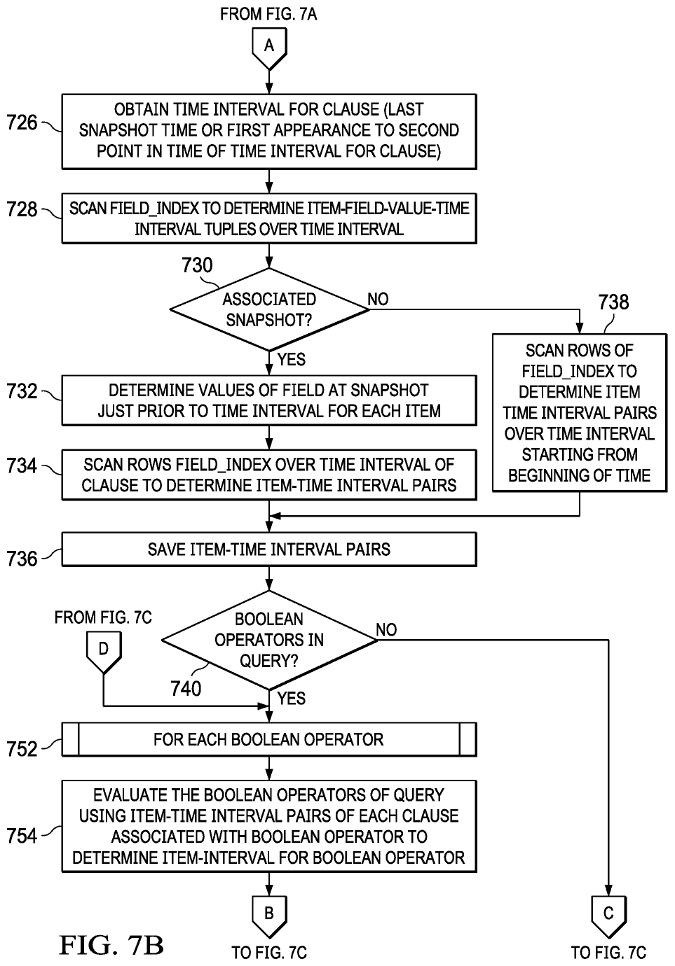

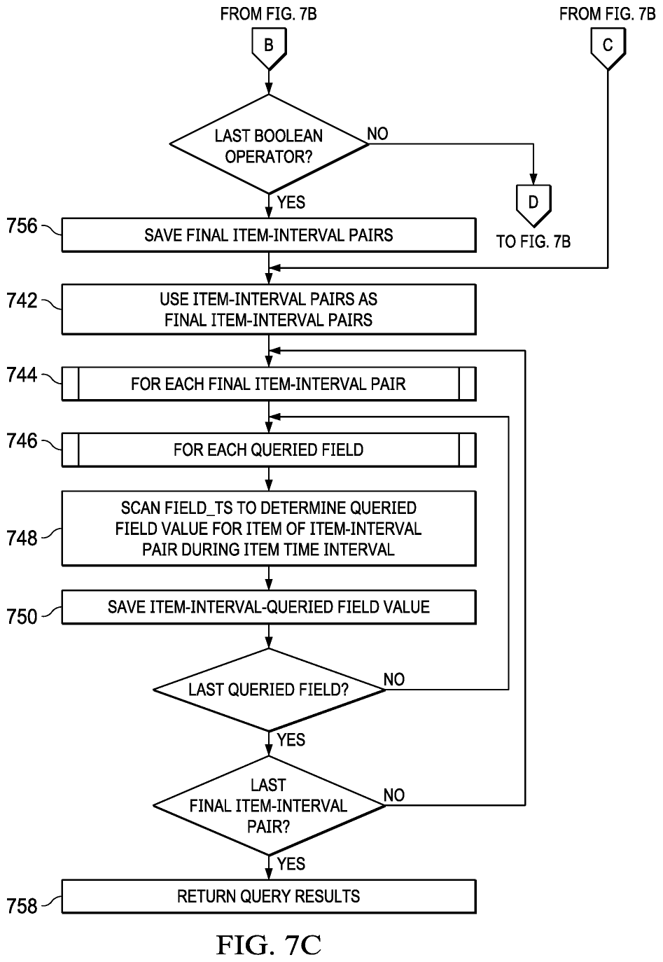

It may be useful now to discuss embodiments of evaluating a query using embodiments of the tables disclosed herein in more detail. Accordingly, FIGS. 7A, 7B and 7C are a flow diagram depicting a method for evaluating a received query using embodiments of the tables discussed. Initially, a query may be received by a system employing embodiments of the tables disclosed herein (STEP 702), such as through a search interface. As discussed, such queries may be received directly from a user through a search interface or from a service or application (e.g., through an Application Programming Interface (API), a web services interface, or another type of interface provided by the system). This query may include one or more queried fields and a set of clauses, where these clauses may be joined by Boolean operators (e.g., AND, OR, NOT, etc.). The set of clauses may, for example, define the parameters or results of the queried.

Each clause of the query may include, for example, a specified field and value joined by an expression or operator (e.g., any operator supported by a data store utilized by the system such as Bigtable or HBase, including for example, equality, prefix, regular expression matching expressions, number ranges such as greater than or less than operator, etc.). The clause may also be associated with time interval having a beginning or first point in time and an ending or second later point in time. For example, in the query “SELECT c WHERE a=1 DURING [t0, t5),” “c” may be the queried value while the clause “WHERE a=1 During [t0, t5)” included “a” and “1” as a specified field and value and the time interval [t0, t5) with a beginning time of “t0” and a second time of “t5”. It will be noted that in some instances a particular clause of a query may not specify an associated time interval. In such instances the clause may be considered as having a time interval associated and specified for the overall query e.g., the clause inherits the time interval associated with the overall query).

Thus, when a query is received the clauses of the query can be determined (STEP 704). In one embodiment, the determination of the clauses of the query may include the construction of a search tree or expression tree based on the Boolean operators and the determined clauses of the query. An expression tree can, for example, be a tree where the internal nodes are Boolean operators and the leaf nodes are the clauses. Each clause of the search tree is thus associated with a field-value pair, an expression or operator (collectively operator), and an associated time interval.

For each clause determined for the query (STEP 706), the time interval of the clause can be determined (STEP 708) along with the associated field-value pair of the clause (STEP 710). The VALUE_INDEX table can then be scanned to determine if there are any matching field-value pairs for that clause based on the expression (e.g., equality, prefix, greater than, less than, etc.) of the clause (STEP 712). This scan may entail determining if there any rows of the VALUE_INDEX table having a primary key that includes the field-value pair associated with the clause (e.g., and any other terms of the clause such as the immutable dimensions of the table).

If a matching field-value pair for the clause is determined (Y branch of STEP 714) the estimated count and first time may be determined (STEP 716) and saved in association with the clause (STEP 718). The count can be determined from the row of the VALUE_INDEX table including the matching field-value pair. As will be recalled, this count may be an estimated count of the number of matches for that field-value in the FIELD_INDEX table or may be an estimated number of rows that a scan of the FIELD_INDEX table will have to pass over to resolve the field-value pair. Additionally, the first time (e.g., timestamp) may be determined for the clause from the row of the VALUE_INDEX table including the matching field-value pair. This first time will be either the time of the last snapshot for the field value pair as stored in the row for the matching field-value pair, if it exists, or the time that field-value pair was first seen (e.g., again as stored in the row of the matching field-value pair) or the beginning of time in cases where there is no last snapshot (e.g., the value for the snapshot time is NULL or a snapshot time does not exist in the row). This time may be used to bound a subsequent scan in the FIELD_INDEX table as will be discussed. It can then be determined if this is the last clause (STEP 720). If not (N branch of STEP 720) the next clause will be evaluated.

It will be noted here that while the flow diagram of FIGS. 7A, 7B and 7C depicts loops for scans of the tables involved (e.g., a scan of the VALUE-INDEX table for each clause). It will be realized that that this depiction is purely for purposes for ease of illustration and that these scans may be batched or otherwise performed in parallel (e.g., such that a single scan of the VALUE-INDEX table may be performed for all clauses to obtain any matching field-member value pairs and associated data for that clause during the associated time period. In this way such scans may, for example, be optimized for performance and may speed the execution of such queries while reducing memory usage during the evaluation of such queries.

Thus, after a scan of the VALUE_INDEX table has been performed for each clause of the query (Y branch of STEP 720), each clause of the query is associated with the field-value pair, and, if any matching rows in the VALUE_INDEX were found, a time interval over which that field-value pair was seen in at least one item and a count for that field-value pair. The time interval for the clause now has a beginning or first point in time that is the time of the last snapshot for the field value pair of the clause, if it exists, or the time that field-value pair was first seen (e.g., again as stored in the row of the matching field-value pair) or the beginning of time in cases where there is no last snapshot, and a second point in time comprising the second later point in time of the original time interval for the clause (e.g., which may be the same as the query interval).

In some embodiments the clauses of the query may now be ordered by ordering the field value pairs of the clauses (STEP 724). This ordering may be based on the position of a clause in the search tree and the count (e.g., of items or rows as determined from the VALUE_INDEX table) associated with a clause, where the clauses that are higher up in (e.g., closer to the root of) the search tree and have a lower count may be ordered before those clauses that are lower in the search tree and have a higher count. This ordering may be intended to prune the search tree when possible to save the computing resources that may be needed to determine the results of clauses below it in the search tree.

Once the clauses are ordered (STEP 722), the clauses may be taken in order (STEP 724) and for each clause, the clause time interval for the clause obtained (e.g., with a first point in time that is the time of the last snapshot for the field value pair of the clause or the time that field-value pair was first seen or the beginning of time, and a second point in time comprising the second later point in time of the original time interval for the clause) (STEP 726). Once the time interval for the clause is obtained, the FIELD_INDEX table can be scanned to determine items that had the field and value over the clause interval, and the associated time intervals over which each of those items had that value for the field (STEP 728). Thus, at the end of the scan, for the clause and associated field and value there will be a set of items which had that field and value, where each item is associated with one or more time intervals (e.g., during the clause time interval) during which the item had that value for that field.

Specifically, a key may be constructed for the FIELD_INDEX Table using the field name and value for the clause and the beginning point (and possibly the second point) in time of the clause time interval to scan rows of the table associated with that field name and value to obtain rows of the table associated with the field and value of the clause that are from a time on or after the beginning time point of the clause interval (e.g., and excluding rows that are from a time after the second point of the clause time interval). At this point, it can be determined if any snapshots are retuned from the scan (STEP 730). Again, it will be noted that because the row keys of FIELD_INDEX are prepended with an indicator (e.g., Boolean) that the row is a snapshot row, during the scan of the FIELD_INDEX table any snapshot rows that include the values of the key being used for the scan will be encountered before any rows that include the value of the key that are not snapshot rows.

This once the scan is started it can be determined if the first row or rows encountered are snapshot rows pertaining to that field and value. If there are any associated snapshots (Y branch of STEP 730), the items associated with that field and value can be determined from the snapshots and the value of the field for each item at a time just before the first time of the clause time interval can be determined from the snapshot and saved (STEP 732). The scan of the FIELD_INDEX table can then be done based on the rows associated with the time interval (e.g., a scan forward in time) to determine each item having that value for the field and, based on the presence value in rows associated with item and the associated timestamps of those rows, value presence time intervals when the field had that value for that item (STEP 734). These item and time intervals can then be stored in association with the clause (STEP 736)

If no snapshots are initially encountered during the scan of the FIELD_INDEX table for the clause (Y branch of STEP 730) then all the rows of the FIELD_INDEX table (e.g., which represent items that had that value at some point since the beginning of time) may need to be scanned to determine the value of that field for each item at a time just before the first time period of the clause time period (STEP 738). The scan of the FIELD_INDEX table can then be done based on the rows associated with the time interval (e.g., a scan forward in time) to determine each item having that value for the field and, based on the presence value in rows associated with item and the associated timestamps of those rows, value presence time intervals when the field had that value for that item. These item and time intervals can then be stored in association with the clause (STEP 736) As can be seen then, any snapshot rows may be encountered first during a given scan of the FIELD_INDEX table (e.g., before non-snapshot rows) and be processed or utilized to avoid subsequent scanning of non-snapshot rows, but additionally, these snapshot rows may be obtained along with non-snapshot rows of the FIELD_INDEX table during a concurrent scan and may save a significant amount of processing time and computing resources.

Again, it will be noted here that while the flow diagram of FIGS. 7A, 7B and 7C depicts loops for scans of the tables involved (e.g., a scan of the FIELD_INDEX table for each clause). It will be realized that that this depiction is purely for purposes for ease of illustration and that these scans may be batched or otherwise performed in parallel (e.g., such that a single scan of the FIELD-INDEX table may be performed for all clauses).

At the end of the scan of the FIELD_INDEX table then, each clause of the search tree has a field-value pair and a set of associated items, where each of the set of items has one or more associated item time intervals during which that field of that item had that value over the item time interval. Thus, it can now be determined if there are Boolean operators in the query (STEP 740). If there are no Boolean operators (N branch of STEP 740), the set of items and associated item time intervals for each item may be used as the final set of item-time interval pairs (STEP 742) (e.g., each item and associated item time interval may comprise a distinct item-interval pair such that there may be multiple final item-interval pairs for each item). Thus, for each final item-interval pair (e.g., item and associated item time interval) (STEP 744), for each of the queried fields (STEP 746), the FIELD_TS table can then be scanned to determine the queried field value for the item over the associated item time interval (STEP 748). Specifically, a key for the FIELD_TS table can be constructed based on the item, the item time interval and the queried value to scan the FIELD_TS table for one or more rows of the FIELD_TS table that include the value for the queried field over the item time interval. The value of the queried field for each item over the associated item time interval associated with each item-interval pair can be saved in association with each final item-interval pair (STEP 750).

If there are Boolean operators in the query (Y branch of STEP 740), each of the Boolean operators of the search tree may be evaluated against the field-value pairs and sets of associated items and item time intervals to determine the final set of item-time interval pairs (STEPS 752, 754) that match the query (e.g., all the clauses of the query) and these final set of item-time interval pairs saved (STEP 756). The set of final item-interval pairs can then be used to scan the FIELD_TS table as described above where for each final item-interval pair (e.g., item and associated item time interval) (STEP 744), for each of the queried fields (STEP 746), the scan of the FIELD_TS table determines the queried field value for the item over the associated item time interval. The value of the queried field for each item over the associated item time interval associated with each item-interval pair can be saved in association with each final item-interval pair (STEP 750).

The results of the search may then be returned in response to the originally received query (STEP 758). The returning of the results may include returning each item which matched the query along with the value of each queried field for each item that matched along with the item time interval for which that item matched. These results may be aggregated or sorted in certain embodiments by various attributes such as item identifiers, time intervals or other criteria.

While certain embodiments as disclosed herein may provide many advantages, including, for example, being optimized both for high-speed writes of time series data and high-speed queries of contextual or time series data, certain embodiments may further optimize such systems, data storage formats or implementation of evaluating queries to further speed such systems or reduce the use of associated computing resources such as memory or processor time. For example, certain optimizations may present themselves as natural outgrowths of embodiments of the system's structure. Some of these optimizations may include the use of one or more additional tracking structures or tables that include additional data (or data in a different format or keyed differently) where these tracking structures or tables may be used to reduce the processing time, memory usage, etc. required for particular tasks of the system. One such tracking structure or table may be used to track when an item's field changes value (e.g., this table may be referred to as a FIELD_CHANGE_TS table without loss of generality). By maintaining a time series of when item-field-values change, the resolution of queries may be bounded very specifically and the scanning of unnecessary rows reduced or eliminated.

According to one embodiment then, using the presence information provided to the indexing routine, an additional table may be maintained that stores a series of timestamps reflecting moments when the value of an item's field changed. At query resolution time, this additional table may be used to narrow scans of the FIELD_TS table to precise rows, reducing the number of redundant rows required to be processed by the system.

For example, a field that rarely changes but is present on each message (or a number of messages) for an item would produce many rows in FIELD_TS identical in every respect other than timestamp. Although the existence of those rows is important (e.g., in case late data is ingested that must be interleaved with them), queries that attempt to resolve that field's value would be required to scan, deserialize and evaluate each row to determine whether it represented a change. With the introduction of the field change tracking table, however, the specific moments of each change could be known prior to the construction of the FIELD_TS scan, and individual rows known to represent changes could be requested directly

Another optimization may concern immutable fields. For this optimization, in certain embodiments if the format of messages being ingested by the system is augmented to include a list of fields whose values definitively will not change, those values may be stored in a separate, non-temporal table from FIELD_TS (e.g., a key-value table). When asked to resolve those fields later, query expense may be saved by avoiding scanning FIELD_TS to resolve temporal values, and simply returning the immutable values without having to perform any analysis.

In another embodiment, an optimization may involve the user of a cache. Specifically, according to one embodiment in contexts where queries that return specific items are likely to be made close to each other in time, significant expense may be avoided by caching resolved values in a temporally aware store (e.g., capable of maintaining knowledge of values in time) to avoid rescanning the FIELD_TS table through time. Invalidation of this cache may be accomplished by subscribing to the same presence changes that feed the indexing process of embodiments as described.

Yet another optimization that may be performed by embodiments is secondary indexing. Here, if common query structures are known in advance of a query, the system could be modified to transform messages on ingest, grouping fields often queried together, in order to reduce the number of independent clauses that must be executed later. For example, if a common query requested items WHERE department={val} AND name:“{prefix}*”, execution would require identification of a) all items where department={val}, and b) all items where name has prefix {prefix}. Either of these clauses could produce many more items than the intersection of the two.

If, however, messages passing through the system were transformed to append a new field whose name included the value of the department field—for example, “_index_departmentaccounting”—with the value mirroring that of the name field, then queries could be reduced—automatically, if configured correctly—to a single, pre-intersected clause: WHERE_index_department:{val}:“{prefix}*”, avoiding the intermediate state where two clauses with potentially huge numbers of results have not yet been intersected.

It can be understood that application of this technique (append a new field representing a different version of a field:value, allow it to be processed by the system, then automatically modify queries later to use that modified field) can be used in many other ways. For example, to store a case-insensitive version of the department field, add it to the message before processing:

{

department: “Human Resources”,
_ci_department: “human resources”

}

Then queries that ask for case insensitivity could simply prepend a clause's field with _ci_ before query estimation, and the temporal nature of the system is unaffected.

As discussed above, embodiments as disclosed herein may be usefully applied almost any context where the indexing and querying of time based data may be desired. One extremely useful application of these embodiments, however, is in the context of IT management as discussed. Thus, in the context of an IT management system one or more services may query or otherwise utilize the data stored according to embodiments to track and present relationships between items in a computing environment according to their temporal relationships or properties. The services may offer a user interface whereby a user may select or designate items or time periods and interact with the functionality of the interface. The service may compose associated queries are submitted to embodiments of the system described, receive results of those queries and graphically (or otherwise) depict the results of those queries. Thus, the ability to completely and efficiently perform such queries may affect the power and functionality of such services. The interfaces offered by such services may also usefully illustrate the power of embodiments of the systems, data formats and query evaluation systems as presented herein.

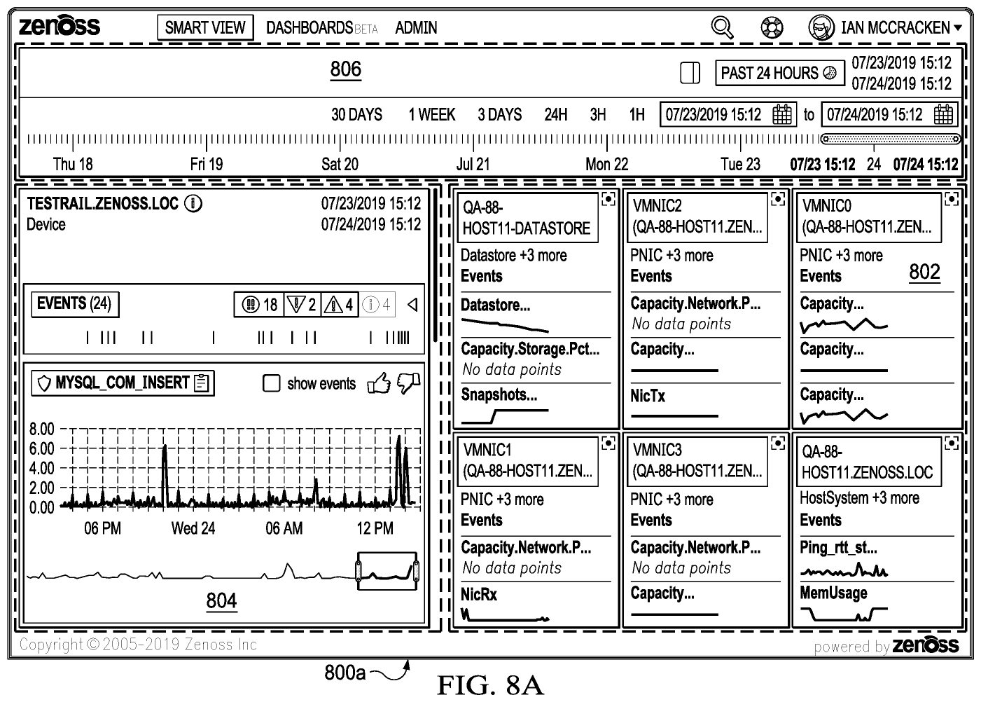

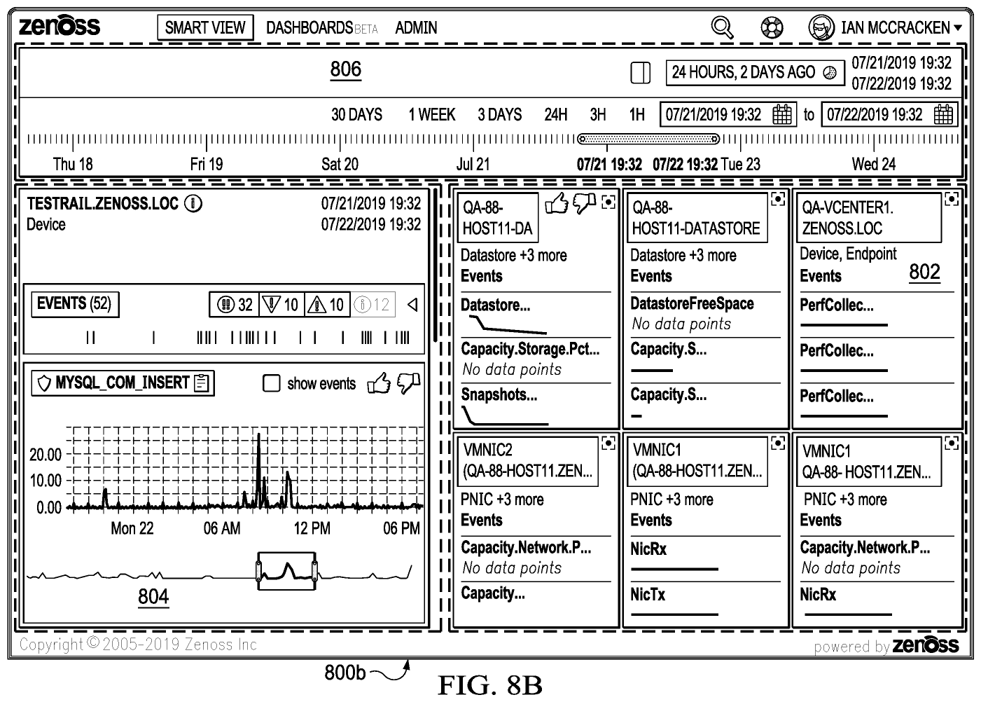

Turning to FIGS. 8A and 8B, embodiment of interfaces provided by a service in an embodiment of an IT management system are depicted. Interface 800a depicts the state of a virtual machine at a first point in time (e.g., the present), while interface 800b depicts the state of that virtual machine at a second point in time (e.g., the past). Notice that in area 802 of the interface represents items of the IT management environment that are related the item (the virtual machine) whose status is depicted in area 804. A user can manipulate time scrubber 806 to determine related components at certain points in time. Thus, as the user manipulates the time scrubber 806 associated queries are sent to the query interface where the queries pertain to the time indicated by the time scrubber and, for example, the item depicted in area 804. Items, fields and values returned by the query may be rendered by the interface in area 802. Thus, each of the boxes in the interface is an item in the system, and the relationships between the items that are tracked as temporal properties are displayed in the interface 800. As can be seen from the example interface, the items displayed in area 802 at a first point in time in interface 800a are different from the items and data displayed in area 802 at a second point in time.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, Python, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a non-transitory computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a set”, “a” or “an” (and “the” when antecedent basis is “a” or “an”) includes both singular and plural of such term (i.e., that the reference “a set”, “a” or “an” clearly indicates only the singular or only the plural). Also, as used in the description herein, the meaning of “in” includes “in” and “on” unless the context clearly dictates otherwise.

### APPENDIX A: DATA INDEXING EXAMPLE

A more detailed example of data indexing according to embodiments is presented. Assume the following message is received at an IT management system:

{

tenant: “acme”,
type: “entity”,
id: “item1”,
timestamp: t0,
data: {

| | |
|---|---|
| alpha: | [“a”, “b”], |
| beta: | [“d”], |
| gamma: | [“e”] |

}

}

When this message is received, one row per field per message is stored in the FIELD_TS table. This table represents a log of all data received, indexed by field (for purposes of this example, it will be understood that a “+” indicates a new row in a table). The FIELD_TS table thus looks like this after the above message is received:

| | ROW KEY | | \|\| VALUES |
|---|---|---|---|
| + | [ acme entity item1 _fields | −t0 ] | \|\| alpha:NULL \| beta:NULL \| gamma:NULL \| |
| + | [ acme entity item1 alpha | −t0 ] | \|\| a:NULL \| b:NULL \| |
| + | [ acme entity item1 beta | −t0 ] | \|\| d:NULL \| |
| + | [ acme entity item1 gamma | −t0 ] | \|\| e:NULL \| |

One row per changed field member value is also stored in the FIELD_INDEX table. This table indexes all items in the data store by value over time. The FIELD_INDEX table thus looks like this after the above message is received:

| | ROW KEY | | |
|---|---|---|---|
| + | [ acme entity _fields | alpha | t0 item1 1 ] |
| + | [ acme entity _fields | beta | t0 item1 1 ] |
| + | [ acme entity _fields | gamma | t0 item1 1 ] |
| + | [ acme entity alpha | a | t0 item1 1 ] |
| + | [ acme entity alpha | b | t0 item1 1 ] |
| + | [ acme entity beta | d | t0 item1 1 ] |
| + | [ acme entity gamma | e | t0 item1 1 ] |

One row per field member value is also stored in the VALUE_INDEX table. This table represents a list of all field value members received, without a time dimension. The VALUE_INDEX table thus looks like this after the above message is received:

| | ROW KEY | | | \|\| FIRST SEEN |
|---|---|---|---|---|
| + | [ acme entity _fields | alpha | ] | \|\| T:t0 |
| + | [ acme entity _fields | beta | ] | \|\| T:t0 |
| + | [ acme entity _fields | gamma | ] | \|\| T:t0 |
| + | [ acme entity alpha | a | ] | \|\| T:t0 |
| + | [ acme entity alpha | b | ] | \|\| T:t0 |
| + | [ acme entity beta | d | ] | \|\| T:t0 |
| + | [ acme entity gamma | e | ] | \|\| T:t0 |

Continuing with the example, now assume that a second message is received:

{

tenant: “acme”,
type: “entity”,
id: “item1”,
timestamp: t2,
data: {

| | |
|---|---|
| alpha: | [“a”, “c”], |
| beta: | [“d”], |
| gamma: | [“f”] |

}

}

Again, one row per field is written to FIELD_TS as usual, logging the values seen at that moment in time. The FIELD_TS table thus looks like this after the second message is received:

| | ROW KEY | | \|\| VALUES |
|---|---|---|---|
| + | [ acme entity item1 _fields | −t2 ] | \|\| alpha:NULL \| beta:NULL \| gamma:NULL |

|

| | | |
|---|---|---|
| [ acme entity item1 _fields | −t0 ] | \|\| alpha:NULL \| beta:NULL \| gamma:NULL |

|

| | | | |
|---|---|---|---|
| + | [ acme entity item1 alpha | −t2 ] | \|\| a:NULL \| c:NULL \| |
| | [ acme entity item1 alpha | −t0 ] | \|\| a:NULL \| b:NULL \| |
| + | [ acme entity item1 beta | −t2 ] | \|\| d:NULL \| |
| | [ acme entity item1 beta | −t0 ] | \|\| d:NULL \| |
| + | [ acme entity item1 gamma | −t2 ] | \|\| f:NULL \| |
| | [ acme entity item1 gamma | −t0 ] | \|\| e:NULL \| |

Only values that are new or no longer present are represented in updates to FIELD_INDEX. The FIELD_INDEX table thus looks like this after the second message is received:

| | ROW KEY | | |
|---|---|---|---|
| | [ acme entity _fields | alpha | t0 item1 1 ] |
| | [ acme entity _fields | beta | t0 item1 1 ] |
| | [ acme entity _fields | gamma | t0 item1 1 ] |
| | [ acme entity alpha | a | t0 item1 1 ] |
| | [ acme entity alpha | b | t0 item1 1 ] |
| + | [ acme entity alpha | b | t2 item1 0 ] |
| + | [ acme entity alpha | c | t2 item1 1 ] |
| | [ acme entity beta | d | t0 item1 1 ] |
| | [ acme entity gamma | e | t0 item1 1 ] |
| + | [ acme entity gamma | e | t2 item1 0 ] |
| + | [ acme entity gamma | f | t2 item1 1 ] |

Any new value members seen are written to VALUE_INDEX. The VALUE_INDEX table thus looks like this after the second message is received:

| | ROW KEY | | | \|\| FIRST SEEN |
|---|---|---|---|---|
| | [ acme entity _fields | alpha | ] | \|\| T:t0 |
| | [ acme entity _fields | beta | ] | \|\| T:t0 |
| | [ acme entity _fields | gamma | ] | \|\| T:t0 |
| | [ acme entity alpha | a | ] | \|\| T:t0 |
| | [ acme entity alpha | b | ] | \|\| T:t0 |
| + | [ acme entity alpha | c | ] | \|\| T:t2 |
| | [ acme entity beta | d | ] | \|\| T:t0 |
| | [ acme entity gamma | e | ] | \|\| T:t0 |
| + | [ acme entity gamma | f | ] | \|\| T:t2 |

Further continuing with the above example, now assume that a third message is received:

{

tenant: “acme”,
type: “entity”,
id: “item1”,
timestamp: t4,
data: {

| | |
|---|---|
| alpha: | [“a”, “b”, “c”], |
| beta: | [“d”], |
| gamma: | [“g”] |

}

}

This third message is indexed the same as the others referred to above. The tables thus look as follows after the third message is received:

FIELD_TS:

| | ROW KEY | | \|\| VALUES |
|---|---|---|---|
| + | [ acme entity item1 _fields | −t4 ] | \|\| alpha:NULL \| beta:NULL \| gamma:NULL \| |
| | [ acme entity item1 _fields | −t2 ] | \|\| alpha:NULL \| beta:NULL \| gamma:NULL \| |
| | [ acme entity item1 _fields | −t0 ] | \|\| alpha:NULL \| beta:NULL \| gamma:NULL \| |
| + | [ acme entity item1 alpha | −t4 ] | \|\| a:NULL \| b:NULL \| c:NULL \| |
| | [ acme entity item1 alpha | −t2 ] | \|\| a:NULL \| c:NULL \| |
| | [ acme entity item1 alpha | −t0 ] | \|\| a:NULL \| b:NULL \| |
| + | [ acme entity item1 beta | −t4 ] | \|\| d:NULL \| |
| | [ acme entity item1 beta | −t2 ] | \|\| d:NULL \| |
| | [ acme entity item1 beta | −t0 ] | \|\| d:NULL \| |
| + | [ acme entity item1 gamma | −t4 ] | \|\| g:NULL \| |
| | [ acme entity item1 gamma | −t2 ] | \|\| f:NULL \| |
| | [ acme entity item1 gamma | −t0 ] | \|\| e:NULL \| |

| FIELD_INDEX: | | | | |
|---|---|---|---|---|
| | ROW KEY | | | |
| | [ acme entity _fields | alpha | t0 item1 1 ] | |
| | [ acme entity _fields | beta | t0 item1 1 ] | |
| | [ acme entity _fields | gamma | t0 item1 1 ] | |
| | [ acme entity alpha | a | t0 item1 1 ] | |
| | [ acme entity alpha | b | t0 item1 1 ] | |
| | [ acme entity alpha | b | t2 item1 0 ] | |
| + | [ acme entity alpha | b | t4 item1 1 ] | |
| | [ acme entity alpha | c | t2 item1 1 ] | |
| | [ acme entity beta | d | t0 item1 1 ] | |
| | [ acme entity gamma | e | t0 item1 1 ] | |
| | [ acme entity gamma | e | t2 item1 0 ] | |
| | [ acme entity gamma | f | t2 item1 1 ] | |
| + | [ acme entity gamma | f | t4 item1 0 ] | |
| + | [ acme entity gamma | g | t4 item1 1 ] | |
| VALUE_INDEX: | | | | |
| | ROW KEY | | | \|\| FIRST SEEN |
| | [ acme entity _fields | alpha | ] | \|\| T:t0 |
| | [ acme entity _fields | beta | ] | \|\| T:t0 |
| | [ acme entity _fields | gamma | ] | \|\| T:t0 |
| | [ acme entity alpha | a | ] | \|\| T:t0 |
| | [ acme entity alpha | b | ] | \|\| T:t0 |
| | [ acme entity alpha | c | ] | \|\| T:t2 |
| | [ acme entity beta | d | ] | \|\| T:t0 |
| | [ acme entity gamma | e | ] | \|\| T:t0 |
| | [ acme entity gamma | f | ] | \|\| T:t2 |
| + | [ acme entity gamma | g | ] | \|\| T:t4 |

### APPENDIX B: SNAPSHOT EXAMPLE

A more detailed example of an embodiment of creating snapshots in the FIELD_INDEX table and updating the VALUE_INDEX table in accordance such snapshots is presented. Assume the system ingests messages representing two items, “itemA” and “itemB”. In this example scenario, the “active” field of itemA never changes, while the “active” field of itemB changes from true to false once per unit of time (here represented as tn). The first messages are encountered, respectively, at t0 and t1, thus the FIELD_INDEX table may include the following entries:

ROW KEY
[ acme entity active true t0 itemA 1 ]
[ acme entity active true t1 itemB 1 ]

After nine time intervals have passed, the FIELD_INDEX table, which contains a row for each time a value applies or stops applying to an item, would reflect this with many rows representing the fluctuating state of “active:true” for itemB and only one row for itemA (e.g., which has remained consistently “true” through all the time intervals):

| ROW KEY | |
|---|---|
| | [ acme entity active true t0 itemA 1 ] |
| | [ acme entity active true t1 itemB 1 ] |
| + | [ acme entity active true t2 itemB 0 ] |
| + | [ acme entity active true t3 itemB 1 ] |
| + | [ acme entity active true t4 itemB 0 ] |
| + | [ acme entity active true t5 itemB 1 ] |
| + | [ acme entity active true t6 itemB 0 ] |
| + | [ acme entity active true t7 itemB 1 ] |
| + | [ acme entity active true t8 itemB 0 ] |
| + | [ acme entity active true t9 itemB 1 ] |

A query for items for which “active” is “true” during the interval [t1, t10) must scan from at least the first time that field:value pair was seen (t0) in order to include all correct items in the results—a scan of just the query interval itself (e.g., t1 to t10) would, for example, omit itemA, which did not change during that time period. Because itemB changes so frequently, this means that in order to identify the 2 matching items (itemA and itemB), a query executor must scan at least 10 rows, many of which do not offer any new information (e.g., once itemB has been determined to be included, the other rows for itemB are irrelevant).

Now say the snapshot routine is asked to consider the field:value pair “active”:“true” at t1000. In the interim (between time t9 and time t1000), assume that the “active” field value of itemB has continued to flip back and forth, with a message reporting this value being received at every time interval. The snapshot process would perform a scan similar to a query, and would find a) that 2 items (itemA and item B) matched at time t1000, and b) that a scan of 1000 rows was necessary to determine that information. Since 1000 rows is significantly more expensive than 2 to scan (e.g., greater than the snapshot threshold), the snapshot routine would determine that a FIELD_INDEX snapshot was indeed valuable at t1000 (e.g., a comparison of the 1000 rows, 2 rows, the ratio or difference etc. against the snapshot threshold determines how many excess rows constitute “significantly more” expense). Snapshot rows would thus be written to the FIELD_INDEX table, note the indicator at the beginning of the row key of the snapshot rows (“snap” in this example) that the row represents a snapshot value:

| ROW KEY | |
|---|---|
| + | [snap acme entity active true t1000 itemA 1 ] |
| + | [snap acme entity active true t1000 itemB 1 ] |
| | [ acme entity active true t0 itemA 1 ] |
| | [ acme entity active true t1 itemB 1 ] |
| | [ acme entity active true t2 itemB 0 ] |
| | [ acme entity active true t3 itemB 1 ] |
| | [ acme entity active true t4 itemB 0 ] |
| | [ acme entity active true t5 itemB 1 ] |
| | [ acme entity active true t6 itemB 0 ] |
| | [ acme entity active true t7 itemB 1 ] |
| | [ acme entity active true t8 itemB 0 ] |
| | [ acme entity active true t9 itemB 1 ] |

...

[ acme entity active true t999 itemB 1 ]

The snapshot routing would then write the total number of items that matched at t1000, here 2, to the VALUE_INDEX table, storing along with it the time of the latest snapshot up to that point, t1000:

| | |
|---|---|
| ROW KEY | \|\| VALUES |
| [ acme entity:active:1 ] | \|\| T:t0 \| −t1000 2 \| |

Now imagine a query is put to the system for items matching “active”:“true” during the interval [t1001, t3000). An estimation stage would return the timestamp of the most recent snapshot prior to the query interval (in this example t1000). Instead of scanning FIELD_INDEX from t0, the scan may instead simply read in the values from the snapshot at t1000, and then scan from t1000 to the end of the query interval to identify the remaining matches, saving 1000 rows of scanning when performing the query. The expense of a query may thus be rendered more or less constant, rather than growing unbounded over time.

### APPENDIX C: QUERY EXAMPLE

A more detailed example of the evaluation of queries according to embodiments is presented. The examples as presented are based on the tables as presented and discussed above in Appendix A. As a first example, a query that would return results with a constant field value across disjoint match intervals may be first discussed. Assume the following query is received by the system:
SELECT beta FROM acme:entity WHERE alpha=b DURING [t1, t5)

The first step in evaluating the query is to determine which value members seen by the system satisfy each query term by scanning the VALUE_INDEX table—in this case, an exact row match.

Scanning VALUE_INDEX for row key:
[ acme entity alpha b ]

| ROW KEY | | | \|\| FIRST SEEN |
|---|---|---|---|
| [ acme entity _fields | alpha | ] | \|\| T:t0 |
| [ acme entity _fields | beta | ] | \|\| T:t0 |
| [ acme entity _fields | gamma | ] | \|\| T:t0 |
| [ acme entity alpha | a | ] | \|\| T:t0 |

----------------------------------------

| | | | |
|---|---|---|---|
| [ acme entity alpha | b | ] | \|\| T:t0 |

----------------------------------------

| | | | |
|---|---|---|---|
| [ acme entity alpha | c | ] | \|\| T:t2 |
| [ acme entity beta | d | ] | \|\| T:t0 |
| [ acme entity gamma | e | ] | \|\| T:t0 |
| [ acme entity gamma | f | ] | \|\| T:t2 |
| [ acme entity gamma | g | ] | \|\| T:t4 |

Yields the row:
[acme entity alpha b]: t0

The next step is to map the field-value members that satisfy the query to items that possess that pair and the intervals within the query interval during which it does so.

The IT management system thus scans FIELD_INDEX from a point in time prior to the beginning of the query time interval, so that the state at the beginning of the query interval is known. Conveniently, the “first seen” time from the VALUE_INDEX table scan serves this purpose well. Accordingly, using the field-value member and first seen time from the VALUE_INDEX scan, scanning FIELD_INDEX for rows within the prefix range:

[ [ acme entity alpha b t0 ], [ acme entity alpha b t5 ] )

| ROW KEY | | |
|---|---|---|
| [ acme entity _fields | alpha | t0 item1 1 ] |
| [ acme entity _fields | beta | t0 item1 1 ] |
| [ acme entity _fields | gamma | t0 item1 1 ] |
| [ acme entity alpha | a | t0 item1 1 ] |

-------------------------------------------

| | | |
|---|---|---|
| [ acme entity alpha | b | t0 item1 1 ] |
| [ acme entity alpha | b | t2 item1 0 ] |
| [ acme entity alpha | b | t4 item1 1 ] |

-------------------------------------------

| | | |
|---|---|---|
| [ acme entity alpha | c | t2 item1 1 ] |
| [ acme entity beta | d | t0 item1 1 ] |
| [ acme entity gamma | e | t0 item1 1 ] |
| [ acme entity gamma | e | t2 item1 0 ] |
| [ acme entity gamma | f | t2 item1 1 ] |
| [ acme entity gamma | f | t4 item1 0 ] |
| [ acme entity gamma | g | t4 item1 1 ] |

Yields (id, interval, lastchange) triples within the query interval:
   (item1, [t1, t2), t0)
   (item1, [t4, t4)

The IT management system has now determined that item1 matched the query during the intervals specified.

The final step is to resolve the fields requested to their values during the match intervals. This comprises a scan of FIELD_TS to obtain distinct values during the query interval, then an intersection with the intervals produced by the FIELD_INDEX scan. Using the intersection of the extent of execution results with query interval, as well as the item id that matched and the field requested, scan FIELD_TS for range:

([ acme entity item1 beta -t5 ], [ acme entity item1 beta −t0] ]

| ROW KEY | | \|\| VALUES |
|---|---|---|
| [ acme entity item1 _fields | −t4 ] | \|\| alpha:NULL \| beta:NULL \| gamma:NULL \| |
| [ acme entity item1 _fields | −t2 ] | \|\| alpha:NULL \| beta:NULL \| gamma:NULL \| |
| [ acme entity item1 _fields | −t0 ] | \|\| alpha:NULL \| beta:NULL \| gamma:NULL \| |
| [ acme entity item1 alpha | −t4 ] | \|\| a:NULL \| b:NULL \| c:NULL \| |
| [ acme entity item1 alpha | −t2 ] | \|\| a:NULL \| c:NULL \| |
| [ acme entity item1 alpha | −t0 ] | \|\| a:NULL \| b:NULL \| |

-----------------------------------------------------------------------------

| | | |
|---|---|---|
| [ acme entity item1 beta | −t4 ] | \|\| d:NULL \| |
| [ acme entity item1 beta | −t2 ] | \|\| d:NULL \| |
| [ acme entity item1 beta | −t0 ] | \|\| d:NULL \| |

-----------------------------------------------------------------------------

| | | |
|---|---|---|
| [ acme entity item1 gamma | −t4 ] | \|\| g:NULL \| |
| [ acme entity item1 gamma | −t2 ] | \|\| f:NULL \| |
| [ acme entity item1 gamma | −t0 ] | \|\| e:NULL \| |

Yielding field value interval:
[“d”]: [t0, t5)

Intersecting the field value interval with intervals during which the item matches the query yields the final result:

[

{

id: “item1”,
interval: [t1, t2),
data: {

beta: [“d”]

}

},
{

id: “item1”,
interval: [t4, t5),
data: {

beta: [“d”]

}

}

]

Note that there are two versions of item1 returned, because the query matched during two disjoint intervals within the time interval requested in the query, even though the value of the field requested was constant. That is, even though the value of beta for item1 was [“d”] at time t3, that time is not represented in the results, because the item itself did not match the query at that time.

Turning now to an example of a query that is associated with results with a constant filed value matching across a full query interval, assume the following query is put to the system:
SELECT beta FROM acme:entity WHERE alpha=a DURING [t1, t5)

First, the VALUE_INDEX table is scanned for the key:

| [ acme entity alpha a ] | |
|---|---|
| ROW KEY | \|\| FIRST SEEN |

| | | | |
|---|---|---|---|
| [ acme entity _fields | alpha | ] | \|\| T:t0 |
| [ acme entity _fields | beta | ] | \|\| T:t0 |
| [ acme entity _fields | gamma | ] | \|\| T:t0 |

----------------------------------------

| | | | |
|---|---|---|---|
| [ acme entity alpha | a | ] | \|\| T:t0 |

----------------------------------------

| | | | |
|---|---|---|---|
| [ acme entity alpha | b | ] | \|\| T:t0 |
| [ acme entity alpha | c | ] | \|\| T:t2 |
| [ acme entity beta | d | ] | \|\| T:t0 |
| [ acme entity gamma | e | ] | \|\| T:t0 |
| [ acme entity gamma | f | ] | \|\| T:t2 |
| [ acme entity gamma | g | ] | \|\| T:t4 |

Yielding:
[acme entity alpha a]: t0

Using the key next scan the FIELD_INDEX table for the range:

[ [ acme entity alpha a t0 ], [ acme entity alpha a t5 ] )

| ROW KEY | | |
|---|---|---|
| [ acme entity _fields | alpha | t0 item1 1 ] |
| [ acme entity _fields | beta | t0 item1 1 ] |
| [ acme entity _fields | gamma | t0 item1 1 ] |

-------------------------------------------

| | | |
|---|---|---|
| [ acme entity alpha | a | t0 item1 1 ] |

-------------------------------------------

| | | |
|---|---|---|
| [ acme entity alpha | b | t0 item1 1 ] |
| [ acme entity alpha | b | t2 item1 0 ] |
| [ acme entity alpha | b | t4 item1 1 ] |
| [ acme entity alpha | c | t2 item1 1 ] |
| [ acme entity beta | d | t0 item1 1 ] |
| [ acme entity gamma | e | t0 item1 1 ] |
| [ acme entity gamma | e | t2 item1 0 ] |
| [ acme entity gamma | f | t2 item1 1 ] |
| [ acme entity gamma | f | t4 item1 0 ] |
| [ acme entity gamma | g | t4 item1 1 ] |

This scan of the FIELD_INDEX table yields (id, interval, lastchange) triples within the query interval:
   (item1, [t1, ∞), t0)
The system has now determined that item1 matched the query during the intervals specified in the query.

Finally, using the intersection of the extent of execution results with query interval, as well as the item id that matched and the field requested, the system can scan the FIELD_TS table for range:

([acme entity item1 beta-t5 ],[ acme entity item1 beta−t0]]

| ROW KEY | | \|\| VALUES |
|---|---|---|
| [ acme entity item1 _fields | −t4 ] | \|\| alpha:NULL \| beta:NULL \| gamma:NULL \| |
| [ acme entity item1 _fields | −t2 ] | \|\| alpha:NULL \| beta:NULL \| gamma:NULL \| |
| [ acme entity item1 _fields | −t0 ] | \|\| alpha:NULL \| beta:NULL \| gamma:NULL \| |
| [ acme entity item1 alpha | −t4 ] | \|\| a:NULL \| b:NULL \| c:NULL \| |
| [ acme entity item1 alpha | −t2 ] | \|\| a:NULL \| c:NULL \| |
| [ acme entity item1 alpha | −t0 ] | \|\| a:NULL \| b:NULL \| |

-----------------------------------------------------------------------------

| | | |
|---|---|---|
| [ acme entity item1 beta | −t4 ] | \|\| d:NULL \| |
| [ acme entity item1 beta | −t2 ] | \|\| d:NULL \| |
| [ acme entity item1 beta | −t0 ] | \|\| d:NULL \| |

-----------------------------------------------------------------------------

| | | |
|---|---|---|
| [ acme entity item1 gamma | −t4 ] | \|\| g:NULL \| |
| [ acme entity item1 gamma | −t2 ] | \|\| f:NULL \| |
| [ acme entity item1 gamma | −t0 ] | \|\| e:NULL \| |

yielding the field value interval:
[“d”]: [t0, t5)

Intersecting this field value interval with intervals during which the item matches the query yields the final result:

[

{

id: “item1”,
interval: [t1, t5) ,
data: {

beta: [“d”]

}

}

]

Continuing with examples of queries using these tables, now suppose a query associated with results with disjoint field values matching across the full interval is received:
SELECT gamma FROM acme:entity WHERE alpha=a DURING [t1, t5)

Here, first, scanning the VALUE_INDEX table for the key:

[ acme entity alpha a ]

| ROW KEY | | | \|\| FIRST SEEN |
|---|---|---|---|
| [ acme entity _fields | alpha | ] | \|\| T:t0 |
| [ acme entity _fields | beta | ] | \|\| T:t0 |
| [ acme entity _fields | gamma | ] | \|\| T:t0 |

----------------------------------------

| | | | |
|---|---|---|---|
| [ acme entity alpha | a | ] | \|\| T:t0 |

----------------------------------------

| | | | |
|---|---|---|---|
| [ acme entity alpha | b | ] | \|\| T:t0 |
| [ acme entity alpha | c | ] | \|\| T:t2 |
| [ acme entity beta | d | ] | \|\| T:t0 |
| [ acme entity gamma | e | ] | \|\| T:t0 |
| [ acme entity gamma | f | ] | \|\| T:t2 |
| [ acme entity gamma | g | ] | \|\| T:t4 |

Yields:
[acme entity alpha a]: t0

Using the key, scan FIELD_INDEX for range:

[ [ acme entity alpha a t0 ], [ acme entity alpha a t5 ] )

| ROW KEY | | |
|---|---|---|
| [ acme entity _fields | alpha | t0 item1 1 ] |
| [ acme entity _fields | beta | t0 item1 1 ] |
| [ acme entity _fields | gamma | t0 item1 1 ] |

-------------------------------------------

| | | |
|---|---|---|
| [ acme entity alpha | a | t0 item1 1 ] |

-------------------------------------------

| | | |
|---|---|---|
| [ acme entity alpha | b | t0 item1 1 ] |
| [ acme entity alpha | b | t2 item1 0 ] |
| [ acme entity alpha | b | t4 item1 1 ] |
| [ acme entity alpha | c | t2 item1 1 ] |
| [ acme entity beta | d | t0 item1 1 ] |
| [ acme entity gamma | e | t0 item1 1 ] |
| [ acme entity gamma | e | t2 item1 0 ] |
| [ acme entity gamma | f | t2 item1 1 ] |
| [ acme entity gamma | f | t4 item1 0 ] |
| [ acme entity gamma | g | t4 item1 1 ] |

This scan yields (id, interval, lastchange) triples within the query interval:
(item1, [t1, ∞), t0)
The system has now determined that item1 matched the query during the intervals specified in the query.

Finally, using the intersection of the extent of execution results with query interval, as well as the item id that matched and the field requested, the FIELD_TS table can be scanned for the range:

([ acme entity item1 gamma -t5 ],[ acme entity item1 gamma −t0]]

| ROW KEY | | \|\| VALUES |
|---|---|---|
| [ acme entity item1 _fields | −t4 ] | \|\| alpha:NULL \| beta:NULL \| gamma:NULL \| |
| [ acme entity item1 _fields | −t2 ] | \|\| alpha:NULL \| beta:NULL \| gamma:NULL \| |
| [ acme entity item1 _fields | −t0 ] | \|\| alpha:NULL \| beta:NULL \| gamma:NULL \| |
| [ acme entity item1 alpha | −t4 ] | \|\| a:NULL \| b:NULL \| c:NULL \| |
| [ acme entity item1 alpha | −t2 ] | \|\| a:NULL \| c:NULL \| |
| [ acme entity item1 alpha | −t0 ] | \|\| a:NULL \| b:NULL \| |
| [ acme entity item1 beta | −t4 ] | \|\| d:NULL \| |
| [ acme entity item1 beta | −t2 ] | \|\| d:NULL \| |
| [ acme entity item1 beta | −t0 ] | \|\| d:NULL \| |

-----------------------------------------------------------------------------

| | | |
|---|---|---|
| [ acme entity item1 gamma | −t4 ] | \|\| g:NULL \| |
| [ acme entity item1 gamma | −t2 ] | \|\| f:NULL \| |
| [ acme entity item1 gamma | −t0 ] | \|\| e:NULL \| |

-----------------------------------------------------------------------------

Yielding field value intervals:
   [“e”]: [t0, t2)
   [“f”]: [t2, t4)
   [“g”]: [t4, t5)

Intersecting the determined field value interval with intervals during which the item matches the query yields the final result:

[

{

id: “item1”,
interval: [t1, t2),
data: {

beta: [“e”]

}
},

{

id: “item1”,
interval: [t2, t4),
data: {

beta: [“f”]

}
},

{

id: “item1”,
interval: [t4, t5),
data: {

beta: [“g”]

}
}

]

Note that there are three versions of item1 returned. Although item1 matched across the full query interval, the value of the field requested changed twice during the same interval.

What is claimed is:

1. A data storage and retrieval system, comprising:
a processor; and
a data store, including:
a first table, where a first entry in the first table includes a first primary key including an identifier for an item, a field name and a first timestamp indicating when a message for the item including the field name was received and wherein the first entry includes a field name value for the field name included in the message;
a second table, where a second entry in the second table includes a second primary key including the field name, the field name value, the identifier for the item, a second timestamp indicating when the field name value was valid for the field name and the item, and a presence indicator indicating if the field name value is valid or removed; and
a third table, where a third entry in the third table includes a third primary key message including the field name and the field name value, and wherein the first entry includes a field name value for the field name and wherein the third entry includes a third timestamp of a first time a pair of the field name and the field name value was received in the message and a second time for each time the pair of the field name and the field name value in which the message affected the pair of the field name and the field name value; and
a non-transitory computer readable medium comprising instructions executable on the processor for receiving the message and updating the first table, second table, or third table of the data store based on the message.

2. The system of claim 1, wherein the data store is a columnar data store.

3. The system of claim 1, wherein the third entry in the third table includes a count for the field name and field name value, where the count is associated with a number of second entries in the second table associated with the field name and field name value.

4. The system of claim 1, wherein the second primary key of the second entry in the second table includes an optional snapshot indicator.

5. The system of claim 1, wherein the first timestamp is an inverted timestamp.

6. The system of claim 1, wherein the first primary key, second primary key and third primary key include a tenant and a type associated with the message.

7. A method, comprising:
receiving a message and updating one or more tables of a data store based on the message, the data store including:
a first table, where a first entry in the first table includes a first primary key including an identifier for an item, a field name and a first timestamp indicating when a message for the item including the field name was received and wherein the first entry includes a field name value for the field name included in the message;
a second table, where a second entry in the second table includes a second primary key including the field name, the field name value, the identifier for the item, a second timestamp indicating when the field name value was valid for the field name and the item, and a presence indicator indicating if the field name value is valid or removed; and
a third table, where a third entry in the third table includes a third primary key message including the field name and the field name value, and wherein the first entry includes a field name value for the field name and wherein the third entry includes a third timestamp of a first time a pair of the field name and the field name value was received in the message and a second time for each time the pair of the field name and the field name value in which the message affected the pair of the field name and the field name value.

8. The method of claim 7, wherein the data store is a columnar data store.

9. The method of claim 7, wherein the third entry in the third table includes a count for the field name and field name value, where the count is associated with a number of second entries in the second table associated with the field name and field name value.

10. The method of claim 7, wherein the second primary key of the second entry in the second table includes an optional snapshot indicator.

11. The method of claim 7, wherein the first timestamp is an inverted timestamp.

12. The method of claim 7, wherein the first primary key, second primary key and third primary key include a tenant and a type associated with the message.

13. A non-transitory computer readable medium, comprising instructions for:
receiving a message and updating one or more tables of a data store based on the message, the data store including:
a first table, where a first entry in the first table includes a first primary key including an identifier for an item, a field name and a first timestamp indicating when a message for the item including the field name was received and wherein the first entry includes a field name value for the field name included in the message;
a second table, where a second entry in the second table includes a second primary key including the field name, the field name value, the identifier for the item, a second timestamp indicating when the field name value was valid for the field name and the item, and a presence indicator indicating if the field name value is valid or removed; and
a third table, where a third entry in the third table includes a third primary key message including the field name and the field name value, and wherein the first entry includes a field name value for the field name and wherein the third entry includes a third timestamp of a first time a pair of the field name and the field name value was received in the message and a second time for each time the pair of the field name and the field name value in which the message affected the pair of the field name and the field name value.

14. The non-transitory computer readable medium of claim 13, wherein the data store is a columnar data store.

15. The non-transitory computer readable medium of claim 13, wherein the third entry in the third table includes a count for the field name and field name value, where the count is associated with a number of second entries in the second table associated with the field name and field name value.

16. The non-transitory computer readable medium of claim 13, wherein the second primary key of the second entry in the second table includes an optional snapshot indicator.

17. The non-transitory computer readable medium of claim 13, wherein the first timestamp is an inverted timestamp.

18. The non-transitory computer readable medium of claim 13, wherein the first primary key, second primary key and third primary key include a tenant and a type associated with the message.
